(19) United States
(12) Patent Application Publication
(10) Pub. No.: US 2004/0205116 A1
(43) Pub. Date: Oct. 14, 2004

(54) Computer-based multimedia creation, management, and deployment platform

(76) Inventors: Greg Pulier, Los Angeles, CA (US); John David Busfield, Valencia, CA (US); Brett C. Law, Cerritos, CA (US)

Correspondence Address: STEPHEN D. SCANLON, JONES DAY, 901 LAKESIDE AVENUE, CLEVELAND, OH, 44114, US

(21) Appl. No.: 09/925,962

(22) Filed: Aug. 9, 2001

(51) Int. Cl. G06F 15/16; G06F 15/00; G06F 17/00

(52) U.S. Cl. 709/203; 709/219; 707/104.1; 715/500.1

(57) ABSTRACT

A computer-implemented system and method perform a variety of tasks related to the creation, management, and presentation of multimedia content. Once created, content may be stored for on-demand presentation to a viewer. Alternatively, content can be presented as it is created, as with a live broadcast of an event. The system and method additionally provide a platform from which multimedia content may be presented to viewers. In relation to the presentation of content, the system and method provide the ability to tailor the content to be presented to the viewer based upon specific attributes of the viewer's system and upon the connection established by the viewer's system.

### BACKGROUND AND SUMMARY

The present invention is generally directed to the field of information presentation over a computer network. More specifically, the present invention provides an apparatus and method for creating, managing, and presenting information in a variety of media formats.

Computers communicate over networks by transmitting data in formats that adhere to a predefined protocol. Taking the Internet as an example, a computer that communicates over the Internet encapsulates data from processes running on the computer in a data packet that adheres to the Internet Protocol (IP) format. Similarly, processes running on networked machines have their own protocols and data formats to which the processes adhere, such as the Real Player format for video and audio content, and Hypertext Markup Language (HTML) for content delivered via the World Wide Web.

Formatting content for delivery over a network is a time consuming and exacting task. Further complicating matters is the fact that despite the existence of recognized protocols and data formats, the processes running on networked computers may not strictly adhere to these protocols and data formats. Thus, difficulties arise in having to create multiple versions of the same content for presentation to different processes. For example, if the content is a web page, it may be necessary to have one version for those users who run Netscape Navigator as their web browsing process, and another for those who run Microsoft Internet Explorer. For these reasons and others, creation and management of content to satisfy the varied environment is problematic.

The system and method of the present invention overcome these problems and others. In accordance with the teachings of the present invention, a computer-implemented system and method perform a variety of tasks related to the creation, management, and presentation of multimedia content. Once created, content may be stored for on-demand presentation to a viewer. Alternatively, content can be presented as it is created, as with a live broadcast of an event. The system and method additionally provide a platform from which multimedia content may be presented to viewers. In relation to the presentation of content, the system and method provide the ability to tailor the content to be presented to the viewer based upon specific attributes of the viewer's system and upon the connection established by the viewer's system.

### BRIEF DESCRIPTION OF THE DRAWINGS

FIGS. 1 and 2 are block diagrams that depict a networked computer system for creating, managing and deploying multimedia web applications;

FIG. 3 is a block diagram that describes a multimedia asset management system;

FIGS. 4A-4G are graphical user interfaces that describe the asset management system;

FIGS. 5A-5D are graphical user interfaces used by a template editor to assist the developer in authoring content;

FIGS. 6A-6D are graphical user interfaces used by an application manager to construct web applications;

FIG. 7A is a deployment map that provides an example of how an application's content may be distributed over different servers;

FIG. 7B is a graphical user interface that depicts deployment of assets over different servers;

FIG. 8 is a block diagram that depicts the application hosting system providing applications to users;

FIGS. 9A and 9B are block diagrams that depict the application hosting system providing content to users over a network;

FIG. 10 lists exemplary pseudocode for handling events designed to control a video presentation;

FIGS. 11A through 11C are flow charts depicting an operational flow for presenting a live event to a remote viewer;

FIGS. 12A and 12B are block diagrams that depict the application hosting system with different configurations;

FIGS. 13A and 13B are graphical user interfaces that illustrate real-time alteration of presentation content;

FIG. 14 is a class diagram that depicts the simulation of inheritance properties in a scripting language;

FIGS. 15A through 15E depict exemplary JavaScript source code within an HTML page that illustrates a programming method of simulating the inheritance properties of an object-oriented programming language;

FIGS. 16A through 16E are graphical user interfaces displayed to the user when the JavaScript code of FIGS. 15A through 15E is executed; and

FIGS. 17A and 17B are block diagrams that depict additional exemplary configurations for utilizing the multimedia creation and management platform.

### DETAILED DESCRIPTION OF EXAMPLES OF THE CLAIMED INVENTION

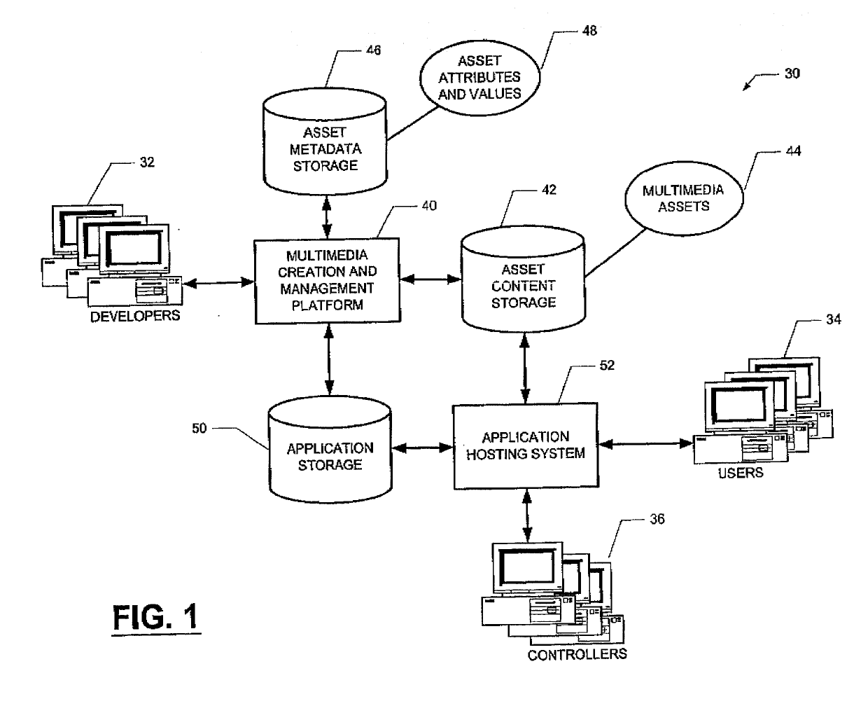

FIG. 1 depicts a networked computer system 30 for efficient and effective creation, management and deployment of multimedia web applications. Application developers 32 author multimedia content through the computer system 30, and deploy the content for access by users 34. While the users 34 are viewing the multimedia content, controllers 36 can inject events through the computer system 30 to modify in real-time what the users 34 are viewing. For example, the users 34 may be viewing a live video stream of a presentation given by a controller 36. The controller 36 may inject events through the computer system 30 that highlight the point the controller 36 is presently addressing. The controller 36 may highlight discussion points by moving an arrow on the users' computer screens, by changing the font characteristics of the discussion point appearing on the users' computer screens, or by similar other ways.

The computer system 30 includes a computer platform 40 by which developers 32 create, store and manage their multimedia applications. The computer platform 40 provides user-friendly interfaces for the developers to incorporate all types of media content in their applications. Such types include images, videos, audio, or any other type of sensory content (e.g., tactile or olfactory). The multimedia content is initially stored as assets 44 in an asset content storage unit 42. For example, an image of Mount Rushmore may be stored as an asset in the asset content storage unit 42, as well as a video of a movie, such as “Little Nicky”.

To assist developers 32 in searching for and organizing the vast number of assets that may be stored in the asset content storage unit 42, asset metadata 48 is stored in the asset metadata storage unit 46. The metadata 48 includes asset attributes, such as the name, type, and location of the assets. The values for the attributes are also stored in the asset metadata storage unit 46. As an example of how asset metadata may be used, suppose that a developer is looking for a video clip from the movie “Little Nicky”. The developer can more quickly and efficiently search the asset metadata storage unit 46 to locate the desired video clip, rather than searching the asset content storage unit 42 (which is much larger due to its storage of many video, audio, image, and other asset files). After the desired assets are located, the applications are generated and stored in an application storage unit 50.

An application hosting system 52 provides the applications to the users 34 upon their request. In order to provide an application, the application hosting system 52 retrieves the application from the application storage unit 50 and provides it to the users 34, usually in the form of an HTML page. Any assets specified in the HTML page are retrieved from the asset content storage unit 42. The specific asset representations to be requested by the user's machine are determined through the use of JavaScript code included in the HTML page and executed on the user's machine. It should be understood that the storage units discussed herein may be of any device suitable for storing information, such as a relational database management system, object-oriented database management system, or files stored in an online server, a disk drive or array of drives.

The application hosting system 52 is also used by controllers 36 to inject events while the users 34 are viewing and listening to the applications. Controllers 36 issue commands to the application hosting system 52 to change (during run-time) the design-time properties of the applications being viewed and heard by the users 34.

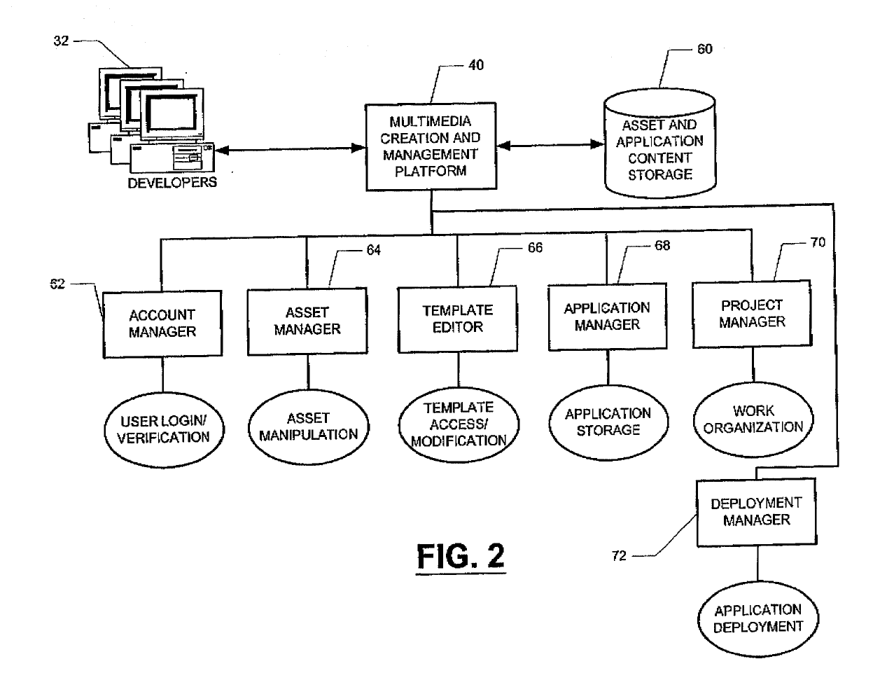

FIG. 2 depicts different managers and editors used by the multimedia creation and management platform 40 to act as an interface between the developers 32 and the different asset and application content storage units 60. The computer platform 40 includes an account manager 62 to oversee user login and verification. An asset manager 64 is used to manipulate the many different types of assets that may be used in an application. A template editor 66 allows the developers 32 to create basic templates that may be used repeatedly in the same project or on different projects. Templates are particularly useful when many developers 32 working on the same project strive to have a level of uniformity in their web page formats.

Once a web application is created with assets and templates, an application manager 68 assists the developers 32 in storing and managing the applications, such as tracking what assets are used in which applications. A project manager 70 provides the developers 32 with a structured mechanism to manage which applications, assets, templates are used on the different projects. A deployment manager 72 assists the developers 32 to more efficiently provide applications to the users. The deployment manager 72 keeps track of which computer servers are to be used for which assets. Since different servers may better handle certain asset types, the deployment manager 72 ensures that the correct asset types are deployed to the correct servers.

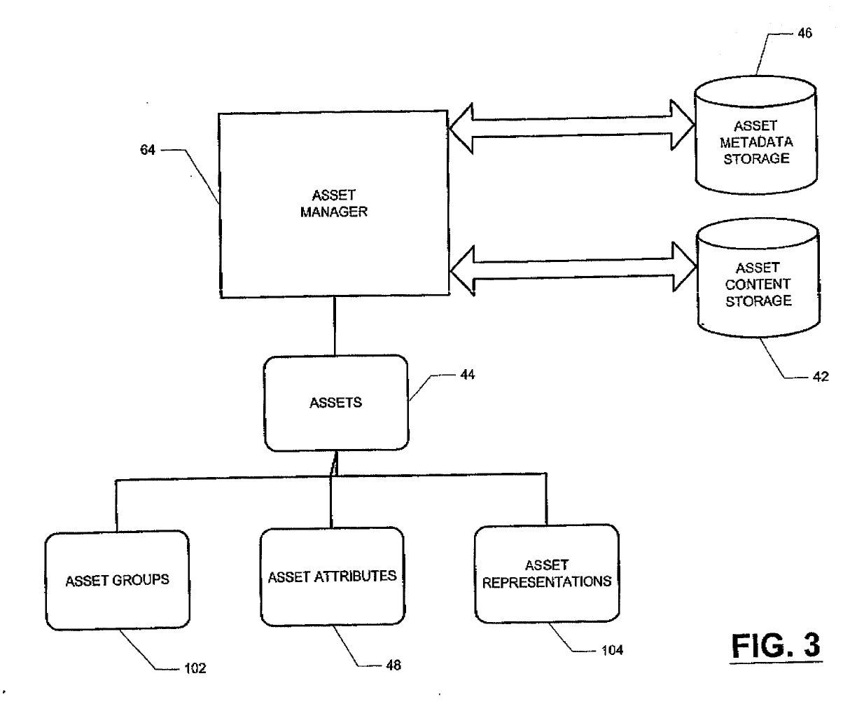

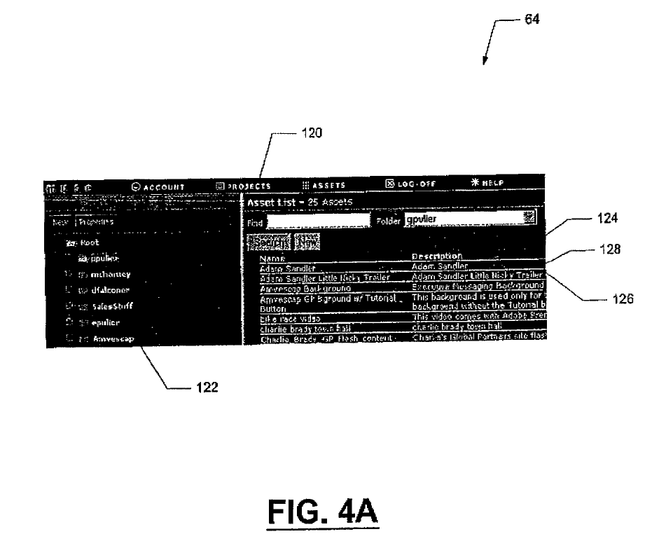

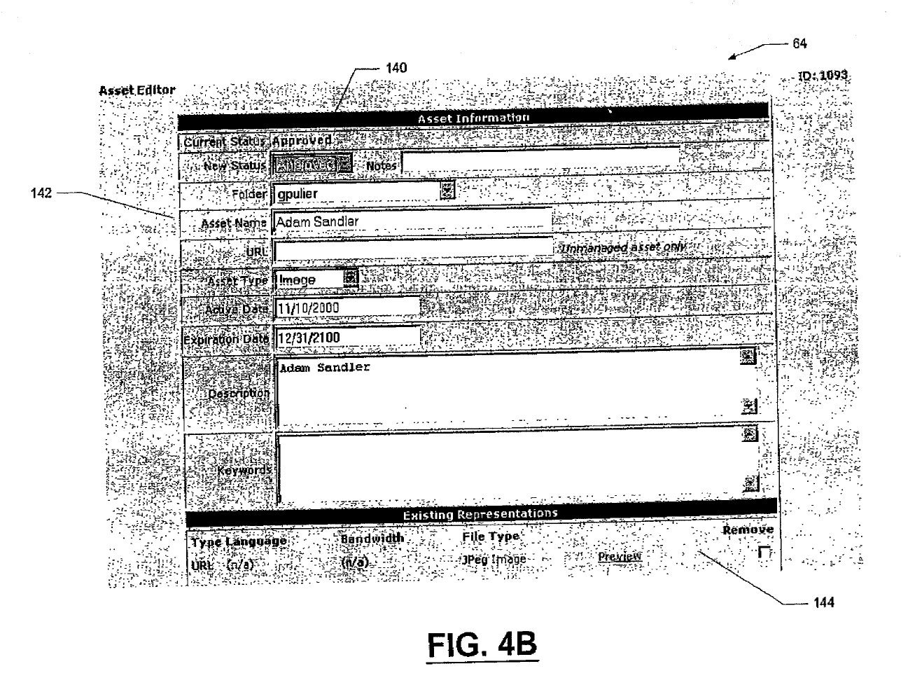

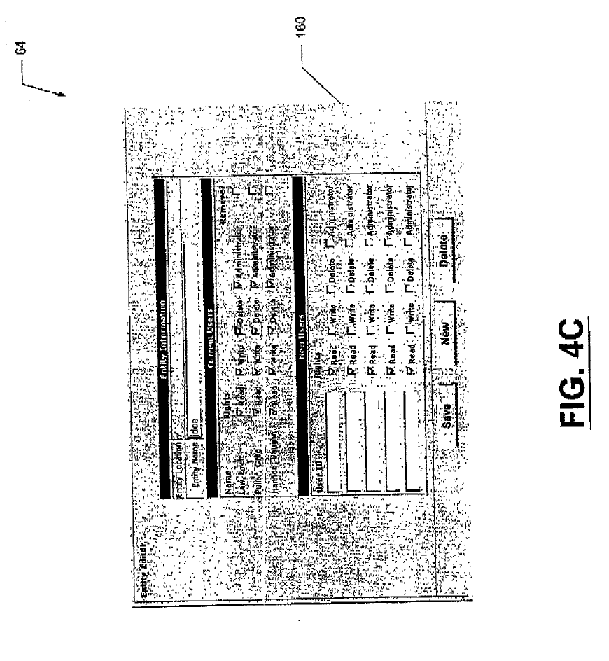

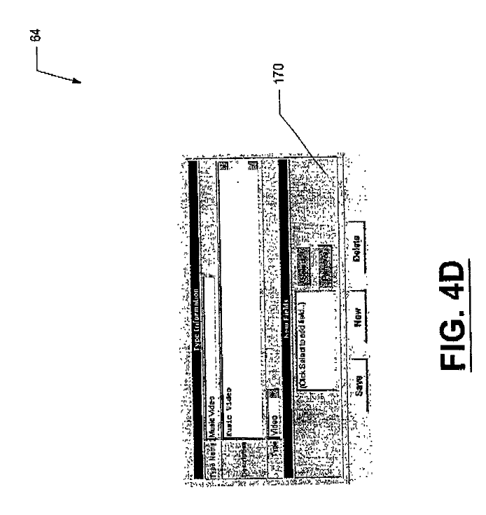

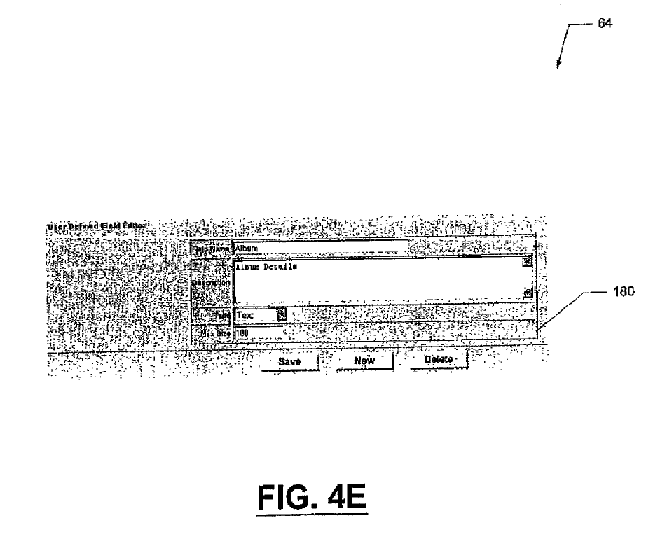

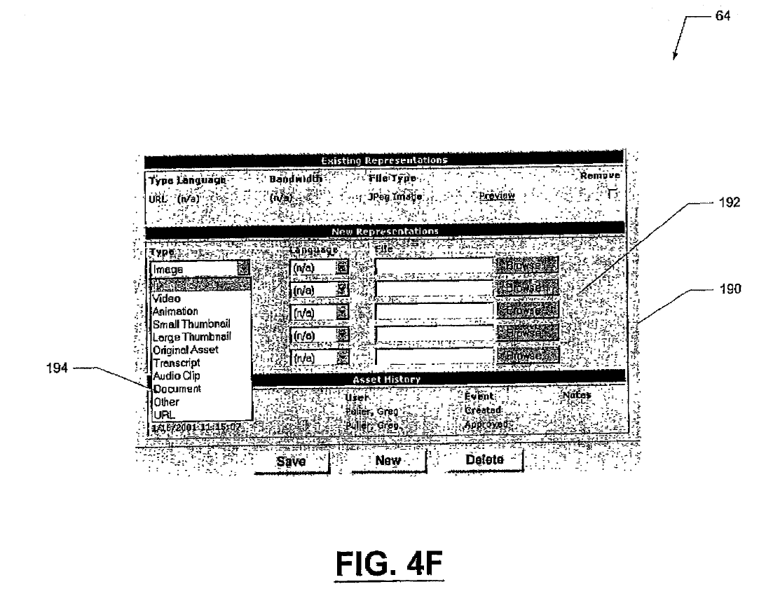

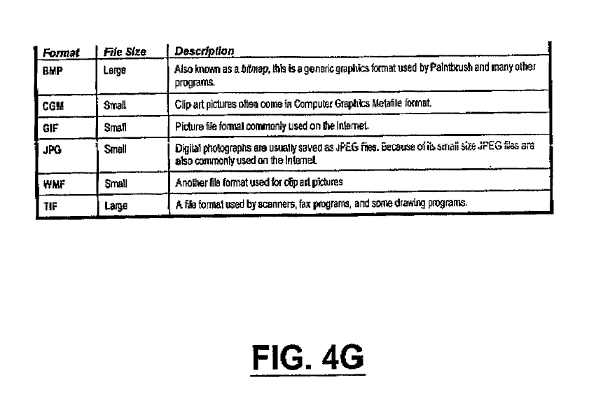

FIGS. 3-4G describe in greater detail the asset manager used by the computer system 30. FIG. 3 depicts how assets 44 are represented and managed by the asset manager 64. An asset 44 is an abstraction of a particular media content, and may have several versions as the asset 44 evolves over time. An asset 44 has attributes and values 48, such as name, projects, and access permissions. For example, the name property of an asset 44 is typically defined by describing the content of the asset 44. An asset 44 may be the movie trailer for the movie “My Cousin Vinnie”, and such an asset 44 may include the movie's title in its name. The asset manager 64 stores the asset's attributes and values 48 in the asset metadata storage unit 46. Asset metadata may be changed to create new attributes or to assign different values to the attributes.

To facilitate management of the assets 44, the assets 44 may be grouped according to a logical aggregation factor and placed in an asset group 102. For example, assets 44 may be grouped by type, such as “movie trailers.”

Each asset may have multiple representations 104. A representation of an asset is a specific format instance of that asset. With reference to the movie trailer example, the asset “Movie Trailer—My Cousin Vinnie” may have multiple representations by creating a representation in QuickTime format, another in Windows Media Player format, and a third in Real Player format. The different representations 104 of assets 44 are placed in the asset content storage unit 42. The asset metadata storage unit 46 reflects what asset representations 104 have been stored for the assets 44. In this way, a subsequently deployed application may determine what representations are available for an asset so that a proper asset format may be provided to a remote user.

FIGS. 4A-4G depict graphical user interfaces used by the asset manager 64 to enable a developer to use assets within an application. With reference to FIG. 4A, interface 120 allows a developer to view what assets are available. A developer selects within region 122 a directory that contains the desired assets. The available assets for the present selection are shown in region 124. For example, row 126 identifies that a movie trailer is available from a movie entitled “Little Nicky”. Row 128 identifies that another asset contains an image of an actor in the movie (i.e., Adam Sandler). If the developer selects row 126, then interface 140 appears as shown in FIG. 4B so that if needed the developer may edit information about the asset.

With reference to FIG. 4B, interface 140 reveals metadata (i.e., attributes and values) of the selected asset. The attributes shown in region 142 include: current status (i.e., whether it has been approved for use in an application), new status, notes, folder (i.e., the directory location of the asset), asset name, file location (which may be expressed as a uniform resource location), asset type, active date (i.e., when the image was first approved), expiration date (i.e., when the asset should no longer be used), description of the asset, and keywords (for use in searching for this asset later).

Interface 140 also includes what representations are available for the asset in region 144. Region 144 shows that a JPEG image representation is available for the selected asset. It should be understood that other representation formats may be used, such as a bitmap image format or a TIFF image format. For the JPEG image format, the type language is not applicable since language refers to a human-spoken language such as English. The language type would most commonly be used with content that is human-language specific such as text or audio recordings. If the asset were a streaming type asset (e.g., streaming video), then the bandwidth entry would include a value that indicates the transmission capability the user should have before the selected particular representation is transmitted to the user. Where a particular type is not applicable, the user has the option of choosing “n/a” as the value for the type.

FIG. 4C depicts interface 160 that manages the access permissions for a group of assets. Read, write, delete, and administrator access privileges may be selected on a per user basis. Thus, different project teams may work on different assets without interfering with other developers' projects.

FIG. 4D depicts an interface 170 that allows a developer to create a new asset type that more specifically describes the asset. Interface 170 shows that a developer is creating a new asset type “Music Video” that more specifically describes the video asset. New asset types usually build from higher level asset types, such as image, video, document, etc. A developer can further refine a new asset type by creating new or associating preexisting data fields with the new asset type. FIG. 4E presents an example of this aspect.

With reference to FIG. 4E, interface 180 creates a new attribute named “Album” to be used with the new asset type “Music Video”. Description, field type, and field size may also be entered in interface 180 to more fully describe the new attribute. The new attribute and its association with the new asset type are stored in the asset metadata storage unit.

An asset may have several different representations that assist the developer in categorizing assets. For example, suppose a developer wanted to create an array of assets centered on a project. The developer may create an asset name as a placeholder for the purpose of qualifying the details and then add several different types of assets for that name. Thus when it came time to search for the asset name, the developer would have several different representations to select as the asset.

FIG. 4F depicts interface 190 that allows a developer to associate multiple representations with the same asset name. The developer enters the representations into fields 192, and selects for each one what type the representation should be. Pull down box 194 presents a list of types from which the developer selects. A developer may enter several assets with the same type but with different representations. Thus, two assets may contain the same image but in two different formats (such as those shown in FIG. 4G).

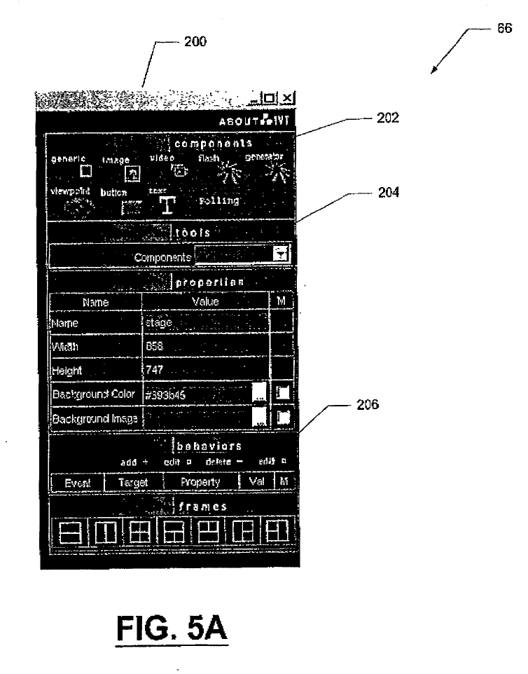

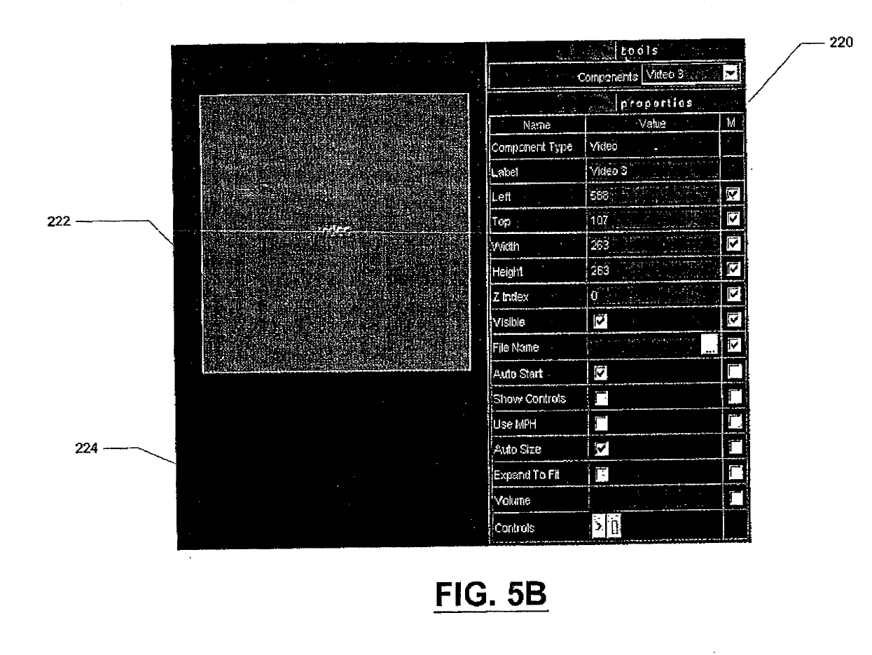

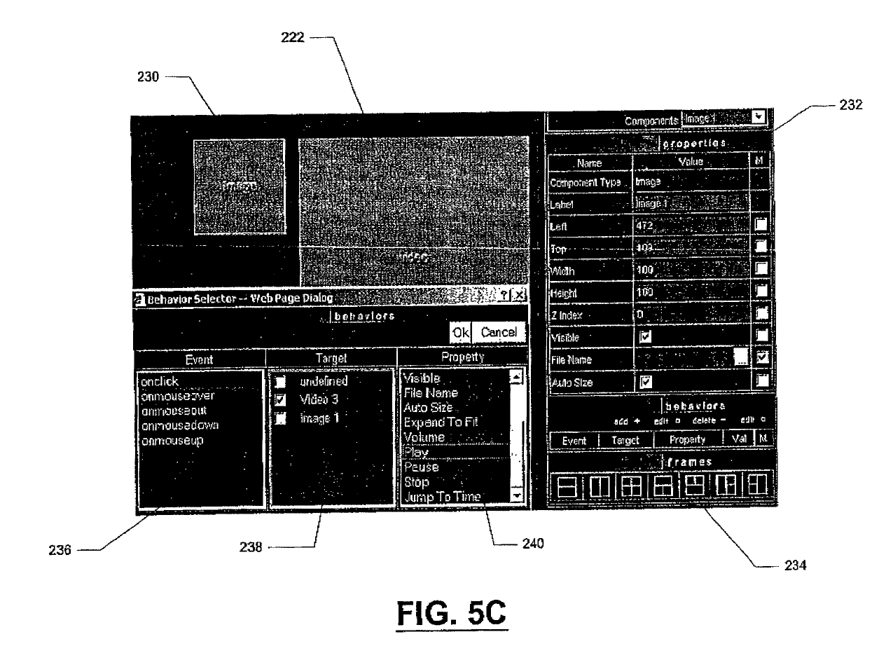

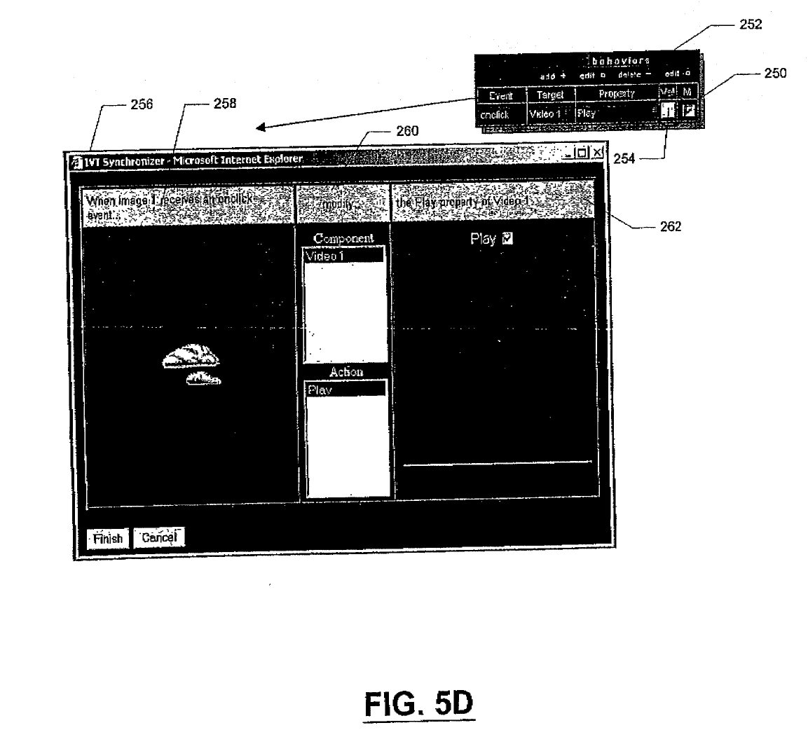

FIGS. 5A-5D depict graphical user interfaces used by the template editor 66 to assist the developer in authoring content. With reference to FIG. 5A, the template editor 66 includes palette 200 that automates the insertion of components, the modification of component properties, and specification of component behavior. Within palette 200, components are shown in palette region 202 and are objects that the developer can place in a template. Examples of components that may be inserted include image components, video components, and flash components. A developer can modify the properties of the components via region 204. Modifiable component properties include color, position, visibility, file names, and other such properties. Behavior of components in an application can be specified via region 206 such that a specific action can be given to a component based upon occurrence of an event (e.g., synchronization, movement, and click patterns).

Once a component has been placed on a template, its properties can be displayed and modified. FIG. 5B shows property information 220 for a video component 222 that has been placed upon a template 224. Position, visibility, file name and location, and other properties are shown as modifiable.

FIG. 5C displays an image component 230 that has been placed adjacent to the video component 222. The properties of the image may be modified at region 232. Furthermore, behavior may be specified for the image component 230 by activating the add behavior icon 234. In this example, the developer wishes the video component to play the video when the user clicks upon the image component 230. Upon activation of the add behavior icon 234, three windows 236, 238, and 240 appear for specifying the desired behavior for the video component. The developer selects in this example the “onclick” event in window 236. Next, the developer selects “Video 3” as the target in window 238. The “Play” property is then selected in window 240. These selections quickly accomplish the goal of having the video play upon a mouse click of the image component 230.

As shown in FIG. 5D, the developer may also set the behavior in a template to be “manageable” by checking box 250 on the behavior palette 252. The checkbox 250 allows the developer to select whether the behavior can be changed when managing the application. Checking box 250 allows the developer to create behaviors in the template that may or may not be manageable at the application level depending on whether box 250 is checked. By clicking the synchronization button 254, the developer is no longer setting the behavior to be managed, the developer is managing it. This is graphically depicted in window 256 by the three message boxes 258, 260, and 262. Message box 258 describes the criterion for when the event is to occur (e.g., when the image component Image 1 receives an onclick event). Below message box 260 is specified the action to take place when the event occurs. In this same location, the recipient of the action is specified (e.g., play the video component Video 1).

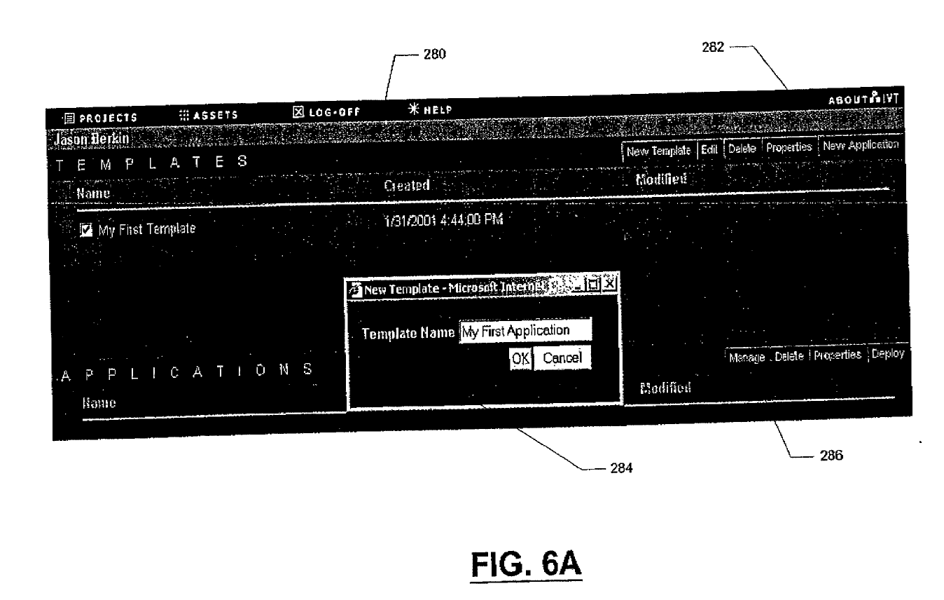

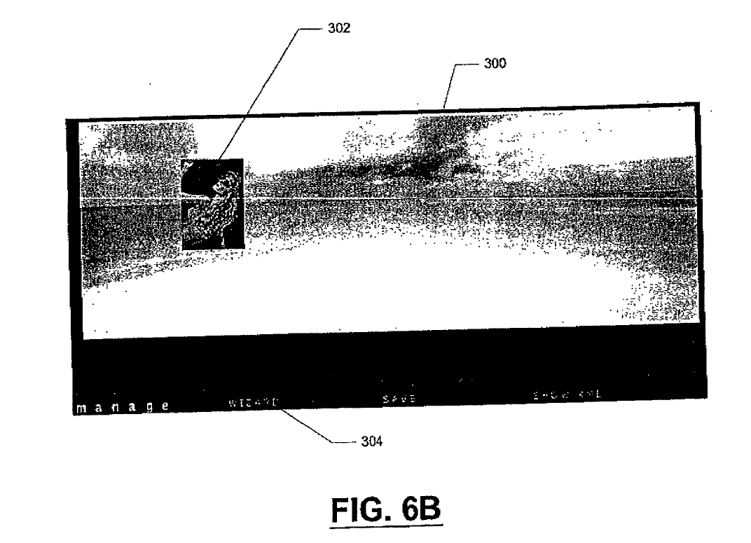

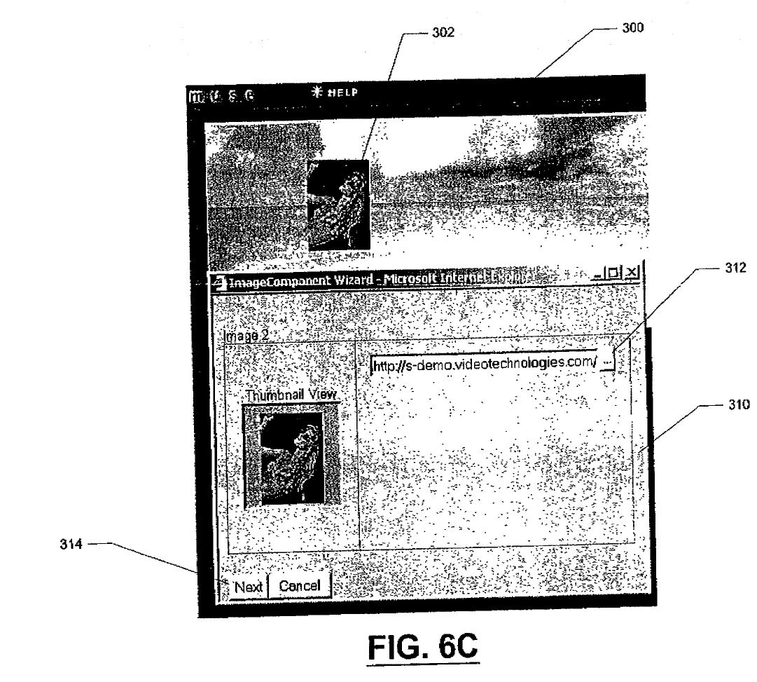

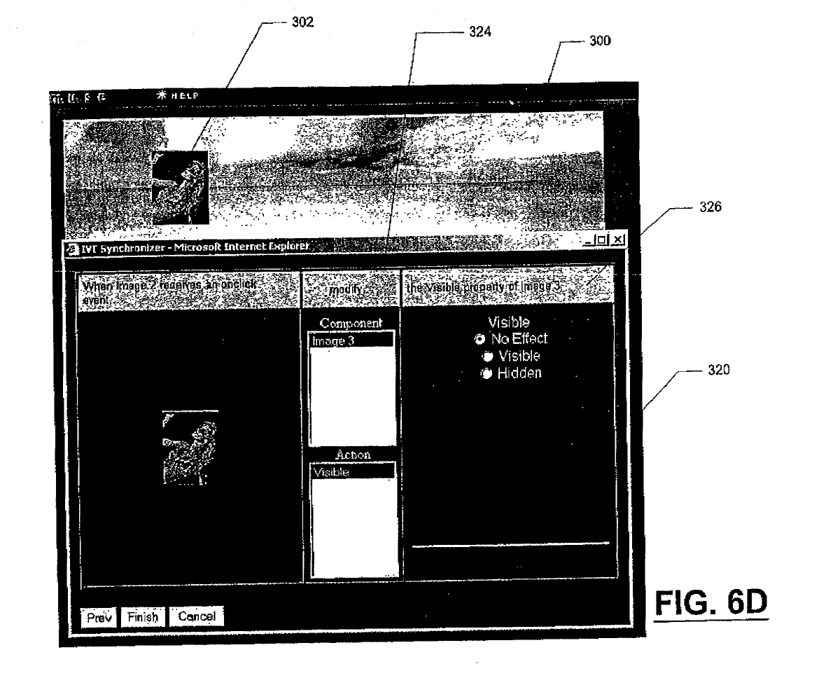

FIGS. 6A-6D depict graphical user interfaces used by the application manager to build an application. The application manager uses the assets and templates to construct applications. With reference to FIG. 6A, a developer activates the new application button 282 on interface 280. The resulting popup window 284 provides an entry field within which the developer enters the name of the new application. To begin populating the new application with content, the developer activates the manage button 286.

FIG. 6B shows window 300 that results from activating the manage button. The new application is automatically populated with content selected during the template construction phase. In this example, image component 302 was inserted into the window 300 since it was included in the underlying template. To modify properties or behavior of the image component 302, the wizard sequence button 304 is activated.

FIG. 6C shows the first popup window 310 in the wizard sequence. If desired, the developer may specify that a different asset should be used instead of the image component 302. The developer can change assets by activating button 312. This allows access to the asset manager so that the developer can select other assets for the application. If the developer is satisfied with the image component 312, then the developer activates the next button 314.

After the next button has been activated, popup window 320 appears in FIG. 6D so that the developer may synchronize assets with each other. In this example, image component 302 is to be synchronized with another image component (i.e., Image 3). Window 322 indicates that the criterion triggering the action is when the image component 302 receives an onclick event. Area 324 shows that the target component's property may be modified upon the criterion occurring. Area 326 shows that the developer may select among three options to modify the visibility property of the target image component (i.e., Image 3). The first option does not change the visibility option. The second option renders the target image component visible, while the last option renders the target image component invisible. Through such a wizard sequence, the user can quickly add content to the application as well as specify complicated behavior, such as component behavior synchronization.

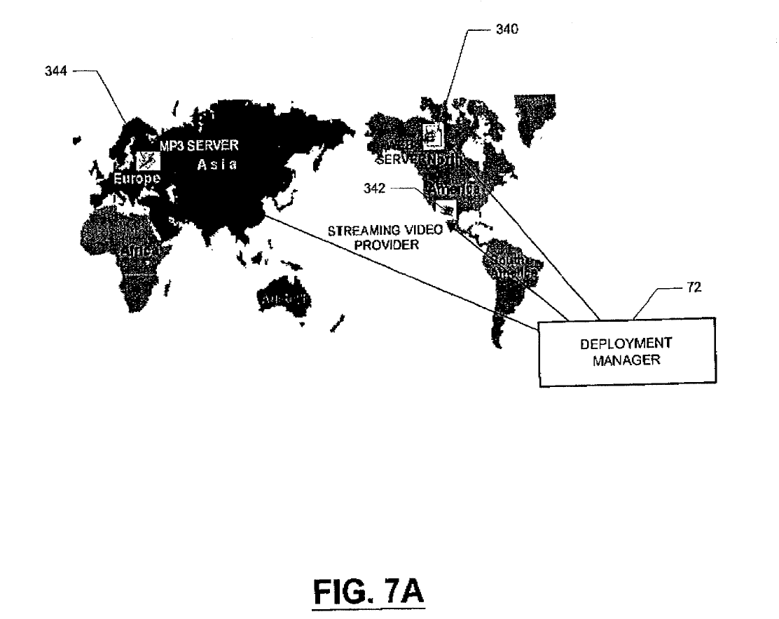

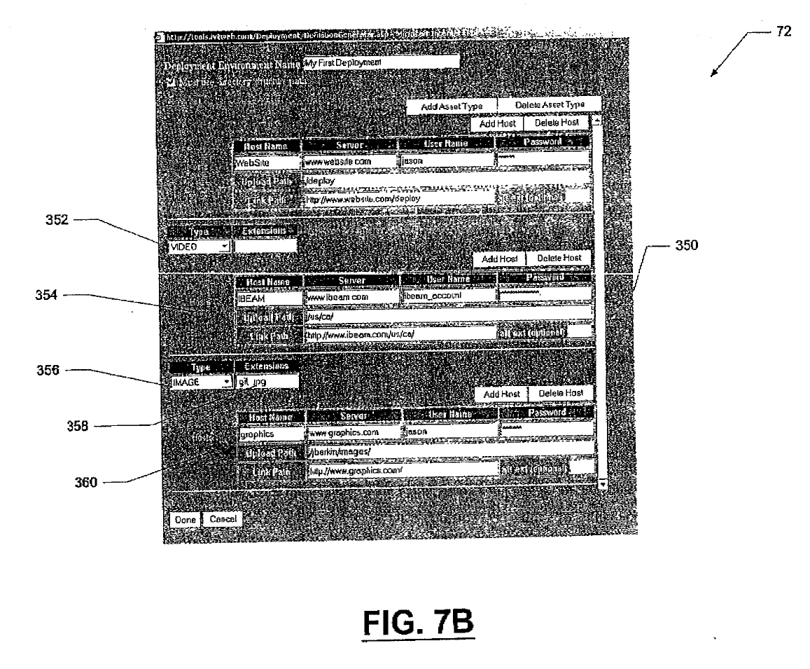

After the web application has been created, the deployment manager 72 helps to optimize the storage and distribution of the application. FIG. 7A illustrates how an application's different content may be distributed over several different servers such that each content is stored on a server that best handles that content. An exemplary optimal allocation is as follows: a web server 340 in Canada may be optimal in serving Hypertext Markup Language pages and images; a streaming media server 342 may optimally deliver video stream; and an MP3 server 344 may work best with audio files.

FIG. 7B shows an interface 350 of the deployment manager 72 that assists in properly storing the different types of assets to ensure the best delivery. In this example, field 352 contains the video asset type. Consequently, video assets are deployed to the host system designated by reference numeral 354. Likewise, field 356 contains the image asset type and further specifies at field 358 that specific file types (e.g., GIF and JPEG image files) be stored on this host. Thus GIF and JPEG formatted image assets are deployed to the host system designated by reference numeral 358. In area 360, the developer can specify the hosting properties for a particular asset representation.

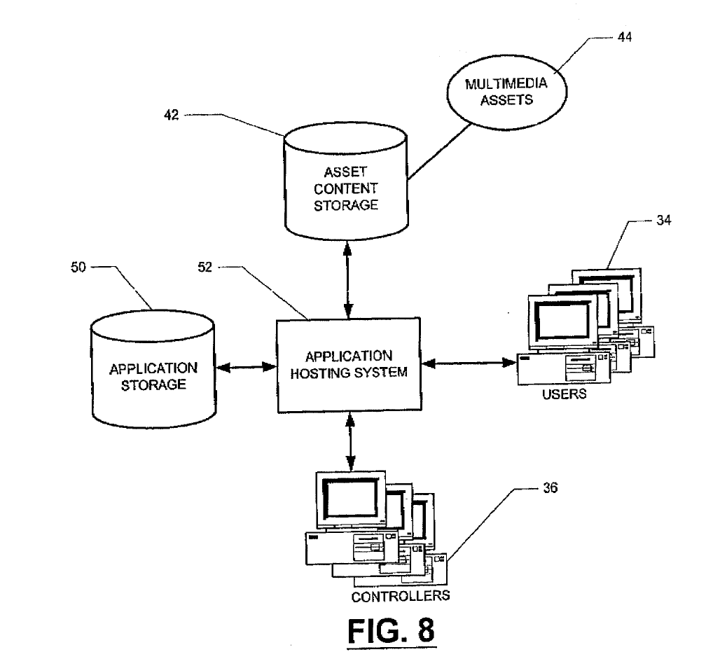

FIG. 8 depicts the application hosting system 52 which provides applications to the users 34. The applications may be used in giving presentations where video of a live speaker or of a previously recorded presentation is streamed to the users 34. In either scenario, controllers 36 may issue commands to the application hosting system 52 to change during run-time the design-time properties of the applications being viewed and heard by the users 34. It should be understood that the term presentation is a broad term as it encompasses all types of presentation, such as a speech or a live football game.

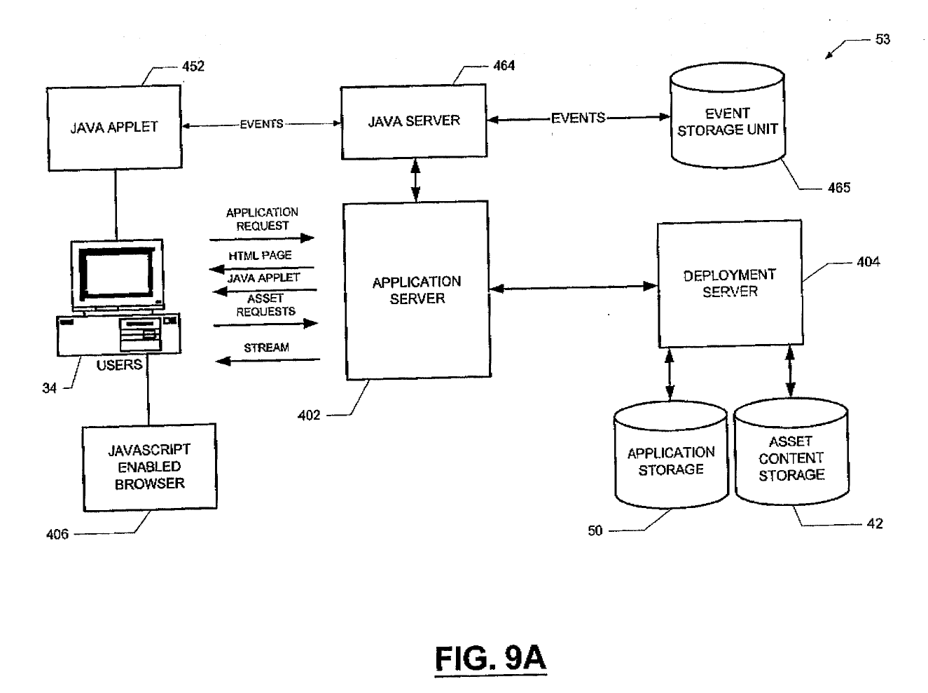

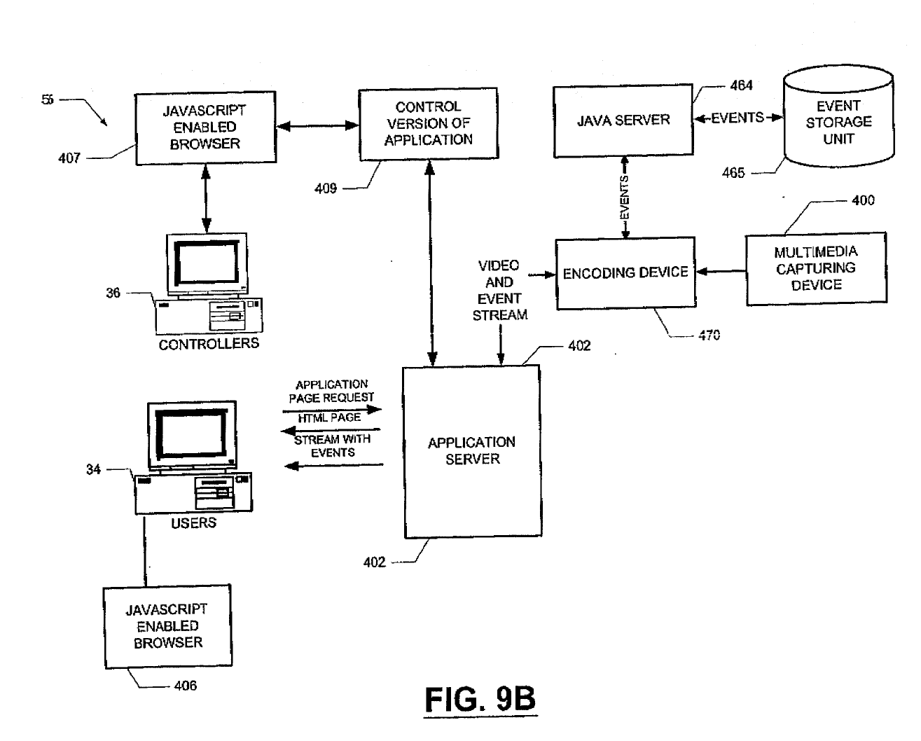

FIG. 9A depicts the architecture of the event injection system for on-demand content viewing 53. A user 34 running a JavaScript-enabled browser 406 requests an application from an application server 402. In response, the application server 402 sends the user's machine an HTML page for the requested application. The application server 402 additionally sends a Java applet 452 to run on the user's machine. The Java applet 452 registers itself with a Java server 464. By registering with the Java server 464, the applet opens a Java pipe between the user's machine and the Java server 464. It is through this pipe that the user's machine will receive events sent by the Java server 464.

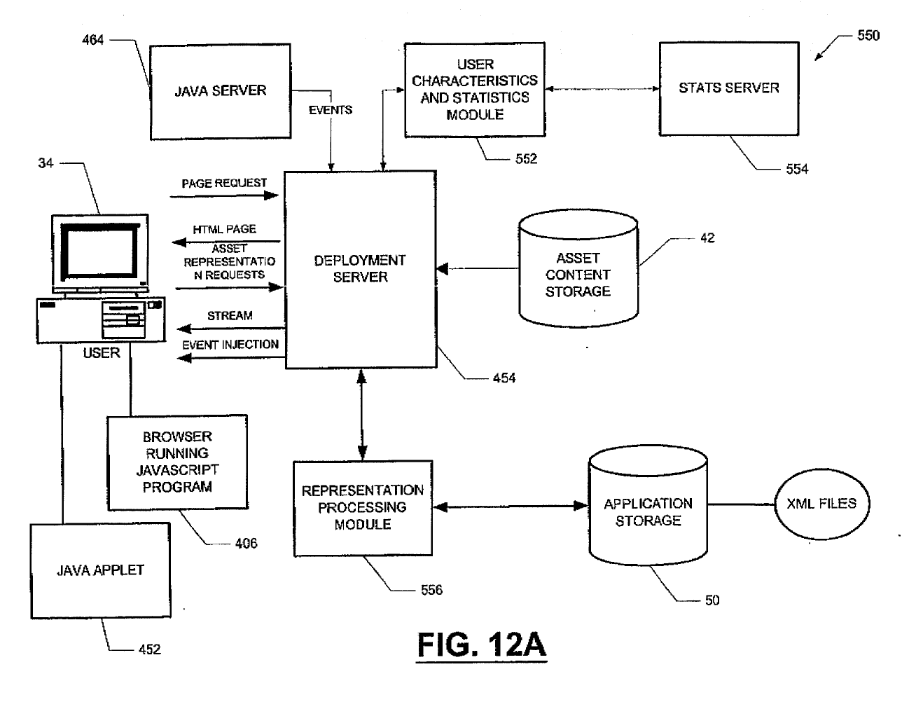

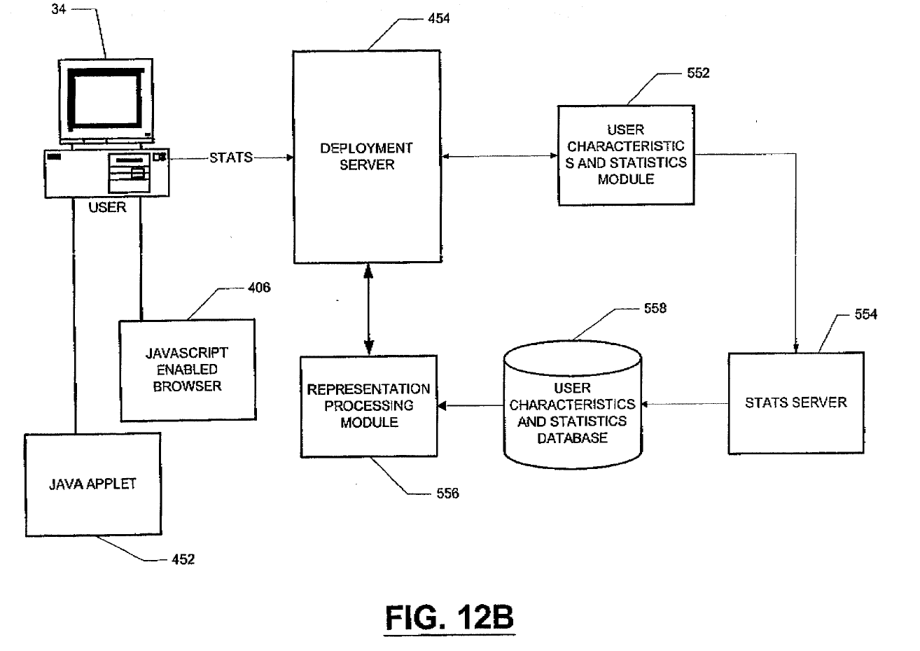

The user's machine then makes requests for content from the application server 402. The application server 402 obtains the content from a deployment server 404. The deployment server 404 in turn retrieves the requested content from the application storage unit 50 and the asset storage unit 42. (The application information stored in the application storage unit 50 and the asset information stored in the asset storage unit 42 are preferably expressed in an eXtensible Markup Language format (XML); an example of which is described below in reference to FIGS. 12A and 12B).

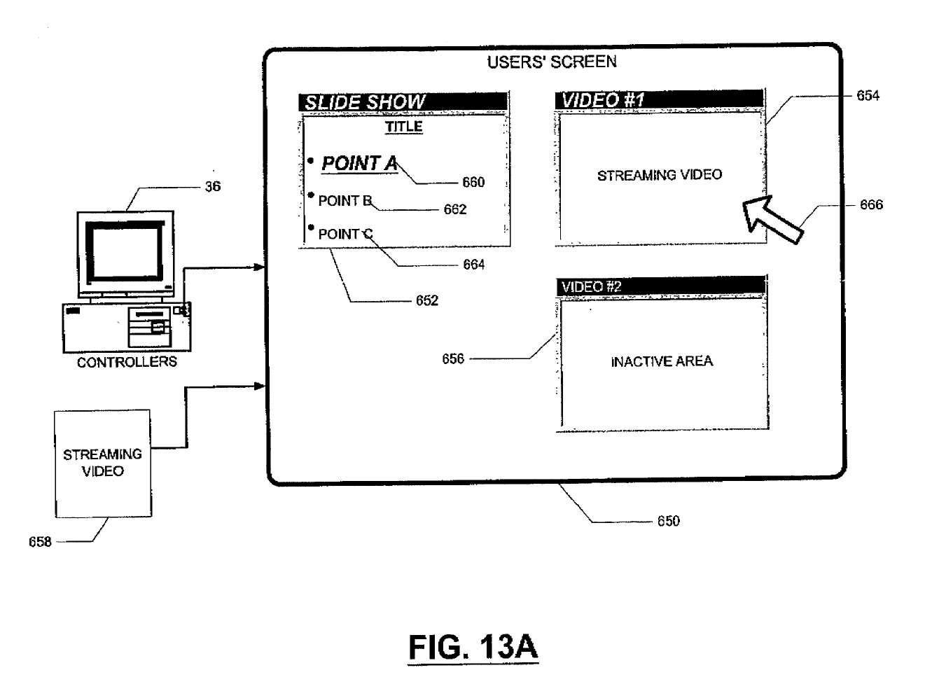

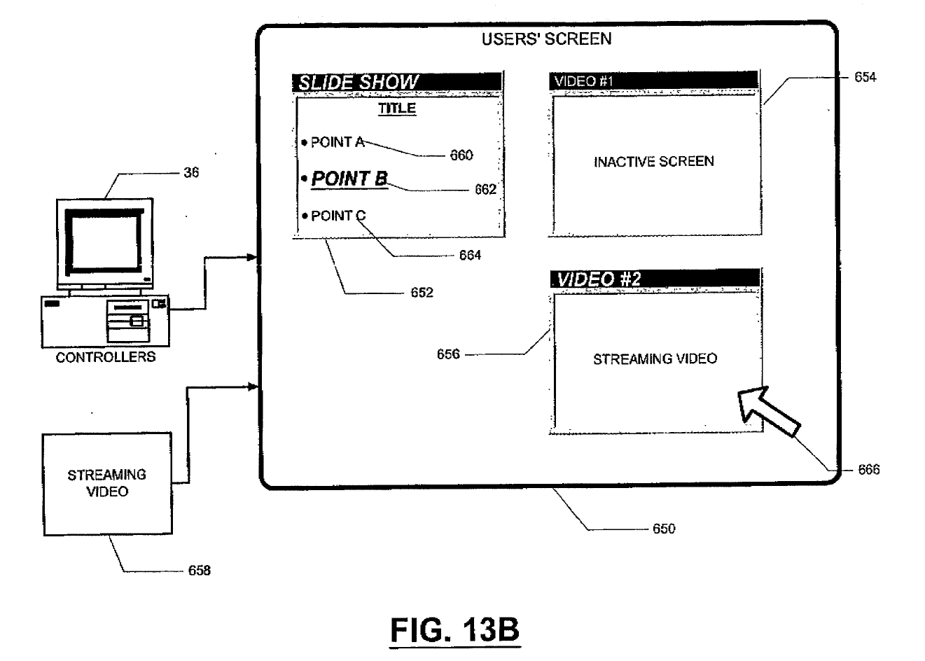

The application server 402 sends the requested content to the user's machine. During the presentation of the content, the Java applet 452 running on the user's machine receives events from the Java server 464. These events cause the Java applet to respond and change aspects of the content being presented (an example of which is described below in reference to FIGS. 13A and 13B). The Java server 464 retrieves stored events from an event storage unit 465. After retrieval, these stored events are sent by the Java server 464 to the Java applet 452 running on the user's machine.

FIG. 9B depicts the architecture of the event injection system for live content viewing 55. When presenting live content, a controller 36 running a JavaScript-enabled browser 407 requests a control version of the application 409 from an application server 402. The control version of the application 409 allows the controller 36 to create events that are injected during the presentation of the live content.

A user 34 running a JavaScript-enabled browser 406 on his machine makes a request for an application with live content from the application server 402. The application server 402 sends the user's machine an HTML page for the display of the requested content. The HTML page contains JavaScript code which serves to handle events received by the user's machine during the presentation of the requested content.

Live content is initially captured by a multimedia capturing device 400. This device may be a video camera with audio capabilities and a converter to convert a native signal containing the live content from the camera to a digital signal. The digital signal from the multimedia capturing device 400 is then sent to an encoding device 470 which encodes the digital signal into a preselected format. Among those formats which may be suitable are the QuickTime movie format and the Real Player format. The encoding device 470 then sends the encoded content to the application server 402 for delivery to the user's machine.

During the presentation of the content, the controller 36 can create events to alter the presentation of the content to the user 34. For example, the controller 36 may create an event that causes the background color of the presentation to change, that causes a graphic to be displayed, or that causes any number of other changes to be made on the user's machine. The events created by the controller 36 are sent to the Java server 464 where a Java event is sent to the encoding device 470. The encoding device then injects the event from the Java server 464 into the content's data stream (preferably via the transmission control protocol (TCP), while the video data stream is sent preferably via the user datagram protocol (UDP); it should be understood that other protocols may be used to perform such functionality). The Java server 464 additionally stores the event in an event storage unit 465. In this manner, events occurring during the presentation of live content can be stored and the live presentation, including events, can be presented as an on-demand presentation at a later time. Such a process can be used for time-shifting live content so that a user 34 can potentially view the beginning of a live presentation as an on-demand presentation while the live content is still being presented to live viewers, or after the live content's presentation has ended.

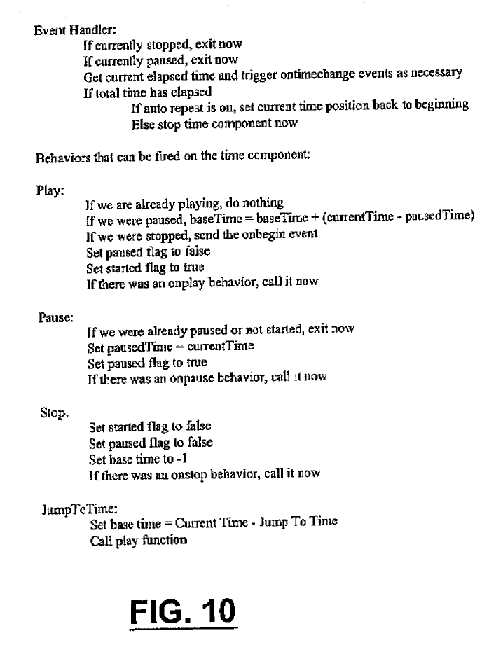

FIG. 10 provides exemplary pseudocode that may be implemented in JavaScript for handling events designed to control a video presentation. Through such code, the users' computers can handle play, pause, stop and jump to time events that are issued by the controller of the presentation.

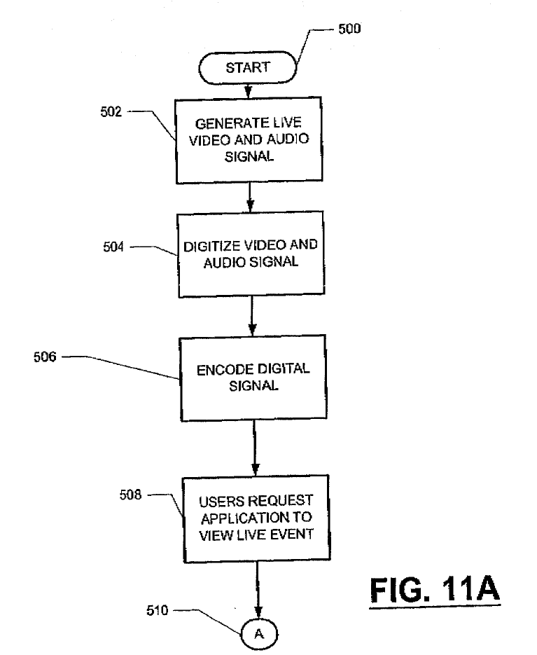

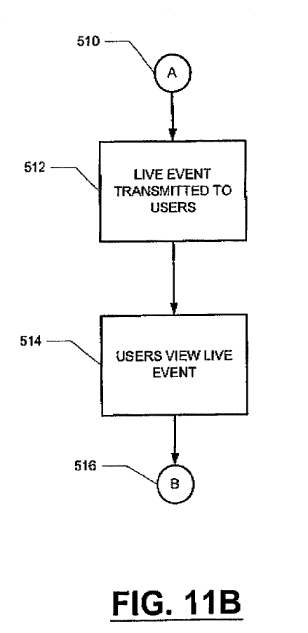

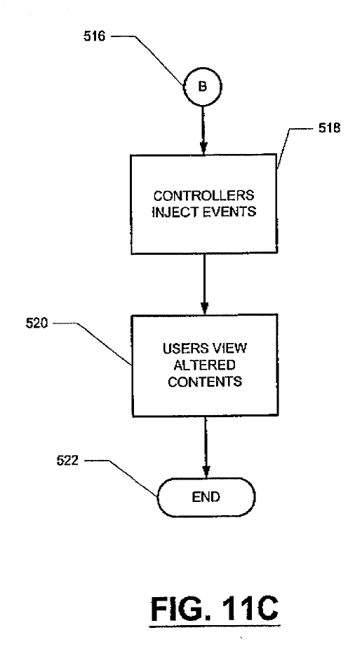

FIGS. 11A through 11C are flow charts depicting an operational flow for presenting a live event to a remote viewer. START block 500 indicates the beginning of the process. In process block 502, a live video and audio content signal are generated via a video camera with audio capabilities. These signals are then digitized, that is, converted into a digital format ready for manipulation by a computer at process block 504. In process block 506 the digital signals created in process block 504 are encoded into industry-used formats such as the QuickTime movie format or the Real Player format. In process block 508 the users viewing the presentation request the application which enables them to view the live event from the server. Continuation block 510 indicates that the process continues on FIG. 11B. With reference to FIG. 11B, process block 512 indicates that the content of the live event is transmitted to users for their viewing. The users view the content on their machines at process block 514. The continuation block 516 indicates that processing continues on FIG. 11C.

With reference to FIG. 11C, the controllers of the live event inject events at process block 518 into the data being transmitted to the users who are viewing the live event. The injected events cause the viewers' machines to respond in predefined ways thus altering the presentation of the live event on the viewers' machine. In process block 520 the users view the altered content on their machines. Processing terminates at END block 522.

FIG. 12A is a block diagram depicting the event injection system for archived, on-demand presentation content 550 which is displayed to a user whenever the user requests the content. It should be noted that live events can be stored as archived events for later viewing on demand.

The user 34 views the content on a computer running a JavaScript-enabled web browsing program 406. The user 34 is also running a Java applet 452 as either a separate process or a subprocess on the user's computer. The user 34 requests an HTML page from the deployment server 454. The deployment server 454 acts as the primary request handler on the server side to deliver the requested content to the user 34. The deployment server 454 transmits the requested HTML page to the user's computer.

Once the requested HTML page has been delivered, the user's web browser 406 parses the HTML page and issues requests to the deployment server 454 for asset representations that are described in the HTML page as file references. An example of a file reference in HTML is the <IMG> tag which indicates that an image file is to be placed at a specific point in the HTML page when presented to the user 34. Those skilled in the art will readily recognize other such file references available for use in HTML.

Prior to responding to the user's asset representation requests, a user characteristics and statistics module 552 and a statistics server 554 gather information relating to the user's computer hardware characteristics, the processes running on or available on that computer, and the connection between the deployment server 454 and the user's computer. More specifically, the information gathered includes the user's browser name and version, the user's Internet Protocol (IP) address, the Uniform Resource Locator (URL) being accessed, the referring page (if any), the user's operating system and version, the user's system language, the connection speed, the user's screen height, width, and resolution, plug-ins available such as QuickTime, Real Player, and Flash, types of scripts enabled such as JavaScript, whether Java is enabled, and whether cookies are enabled. The user characteristics and statistics module 552 and the statistics server 554 gather and store this information along with other usage data for later use. Preferably, this information is gathered with the assistance of a JavaScript program running on the user's computer that was sent by the deployment server 454.

The deployment server 454 requests a presentation generated by a representation processing module 556. The representation processing module 556 then retrieves the application from the application storage unit 50. The application storage unit 50 contains applications in eXtensible Markup Language (XML) format. As an example, the following table contains an XML code excerpt from an application that displays a PowerPoint presentation.

TABLE 1
<?xml version=”1.0”?>
<PRESENTATION version=”1.0”>
<CONTENT version=”1.0”>
<ASSETS>
<ASSET id=″1916″ type=″PRESENT″ udt=″″ version=″1.0″>

<STATUS>APPROVED</STATUS>
<ACTIVEDATE>2001-03-12 00:00:00</ACTIVEDATE>
<EXPIRATIONDATE>2010-12-31 00:00:00</EXPIRATIONDATE>
<NAME>PowerPoint Test</NAME>
<DESCRIPTION>PowerPoint Test</DESCRIPTION>
<KEYWORDS></KEYWORDS>
<NOTES></NOTES>
<METADATA source=″DMP_PPT″ tag=″Labels″>no title,no title</METADATA>
<REPRESENTATION id=″1″ reptype=″PRESENT″ filetype=″PPT″ bandwidth=″NA″

language=″NA″ size=″6041″>

<PREVIEW>http://s-

demo.videotechnologies.com/assetmanager/assets/1916_1.ppt</PREVIEW>

</REPRESENTATION>
<REPRESENTATION id=″2″ reptype=″IMAGE″ filetype=″JPG″ bandwidth=″NA″

language=″NA″ size=″21570″>

<PREVIEW>http://s-

demo.videotechnologies.com/assetmanager/assets/1916_2.jpg</PREVIEW>

<METADATA source=″DMP_PPT″ tag=″Label″>no title</METADATA>

</REPRESENTATION>
<REPRESENTATION id=″3″ reptype=″IMAGE″ filetype=″JPG″ bandwidth=″NA″

language=″NA″ size=″51196″>

<PREVIEW>http://s-

demo.videotechnologies.com/assetmanager/assets/1916_3.jpg</PREVIEW>

<METADATA source=″DMP_PPT″ tag=″Label″>no title</METADATA>

</REPRESENTATION>

</ASSET>
.
.
.

The application contains a slide that was originally created in PowerPoint Tags and converted to two JPEG images at different resolutions. Therefore, the slide asset has three asset representations as respectively identified within the code as id=“1”, id=“2”, and id=“3”. The asset information for these three assets are contained within the opening and closing <ASSET> tags. The value within the opening and closing <STATUS> tags indicates that the asset has been approved for use. Appropriate tags provide designations for dates upon which the asset was activated for use and when the asset will expire. The asset is named within the opening and closing <NAME> tags and described as a PowerPoint Test within the opening and closing <DESCRIPTION> tags. No values have been entered between the opening and closing <KEYWORDS> and <NOTES> tags, but these areas are available for use. Opening and closing <METADATA> tags provide an area for storing appropriate metadata about the asset.

The opening and closing <REPRESENTATION> tags provide descriptions of specific representations available for the asset. Each opening <REPRESENTATION> tag contains an attribute “id” which is assigned a unique value for each asset representation. Other attributes within the <REPRESENTATION> tag include “reptype” for representation type, “filetype” for the specific file format of the representation, “bandwidth” which may be used to specify a minimum connection speed necessary before the representation will be used, “language” which may be used if a specific user language is necessary, and “size” which designates a file size of the representation.

The representation processing module 556 parses the XML file and converts the application into HTML format for the deployment server 454. The specific HTML code created by the representation processing module 556 is created using the information gathered by the user characteristics and statistics module 552 (This process is described in greater detail in FIG. 12B).

During the course of the presentation transmitted by the deployment server, events are generated to change certain displayed content on the user's computer. These events are similar to those generated during a live event transmission and created by a Java server 464. The events are sent to the user's computer where they are handled by the Java applet 452.

FIG. 12B is a block diagram depicting how the content provided to the user 34 is modified based upon the user's characteristics. The user 34, running a JavaScript-enabled web browser 406 and a Java applet 452, requests a presentation from the deployment server 454. At this point, the user characteristics and statistics previously discussed are gathered by the user characteristics and statistics module 552 which may be running on the statistics server 554 or another server such as the deployment server 454. The user characteristics and statistics gathered about the user's session is stored in the user characteristics and statistics database 558. The representation processing module 556 accesses this information when creating the HTML page sent to the deployment server 454.

The representation processing module 556 creates HTML based on the abilities of the user's computer system and known variations from stated standards. For example, despite the fact that the HTML language has been standardized, major web browsers such as Netscape version 4.x and Internet Explorer version 5.x may not fully implement the standards. Additionally, the browser may implement non-standard extensions to the HTML language or have other proprietary features. The representation processing module 556 takes these issues into account when constructing the HTML page.

The application, stored as an XML file, is an abstraction of the presentation to be shown to the user 34. Content for the presentation is described in terms of assets, which themselves are abstractions of content. Thus the application can be described as an aggregation of abstract content descriptions which are placed in an organized XML framework. When converting the XML to HTML, the representation processing module 556 includes within the HTML specific files, referred to earlier as asset representations, so that the user's JavaScript-enabled browser 406 can access the content by requesting a file by its URL. The representation processing module 556 considers the type of content the application contains and the capabilities of the user's system when generating specific HTML code. For example, if the application calls for an animation of the American flag waving, then that asset (the animated flag) may be stored in the system as two separate representations: as a Flash animation and as an animated GIF file. If the user's system lacks Flash capabilities, the HTML created by the representation processing module 556 directs the user's JavaScript-enabled browser 406 to request the animated GIF version of the asset rather than the Flash version. Alternatively, if the user's system has both Flash capabilities and the ability to display animated GIFs, and a fast connection speed, the representation module may choose to include code calling for the Flash representation based upon those specific user 34 system characteristics.

FIGS. 13A and 13B illustrate real-time alteration of presentation content appearing on a user's screen 650. In this example, the presentation uses regions 652, 654, and 656 to display the desired content. Region 652 displays a slideshow (e.g., as may be generated through Microsoft PowerPoint). Region 654 displays a first video which is to be compared during the presentation to a second video shown in region 656.

The first discussion point of the presentation is “Point A” 660 shown in the slideshow region 652. Since “Point A” 660 is the point presently being discussed by the presenter, “Point A” 660 is highlighted with respect to its font characteristics (e.g., boldfaced, underlined and italicized). After discussion begins for “Point A”, streaming video 658 is transmitted to the user's computer and displayed in the first video's region 654. The second video's region 656 remains inactive since the presenter has not started discussing the second video.

The presenter from the controller's computer 36 injects events to highlight different aspects of the presentation. The events are processed by the user's computer. For example, the presenter may inject events to move arrow 666 for emphasizing different aspects of the first video.

FIG. 13B shows the presenter transitioning to “Point B” 662. To emphasize this point, the presenter injects an event which is received by the user's computer. The event causes the font characteristics of all points in region 652 other than “Point B” 662 to be deemphasized. Thus, the event causes the font properties of “Point A” 660 to be of a regular font type (and “Point C” 664 remains unaffected by the event). The injected event causes the font properties of “Point B” 662 to be emphasized, and further causes the second video to begin streaming. The presenter injects further events to move the arrow 666 for emphasizing different aspects of the second video.

The events injected to control the presentation on the user's computer are typically handled by a JavaScript program running on the user's web browser. Because of the complexity of the event handling required to achieve such results (e.g., the synchronization of the components within the presentation being viewed), sophisticated and unique programming techniques are required. One technique is modifying the scripting language to simulate object-oriented features, such as inheritance. It must be understood that this technique is not limited to only JavaScript, but includes any scripting type language, especially those used in web page content development.

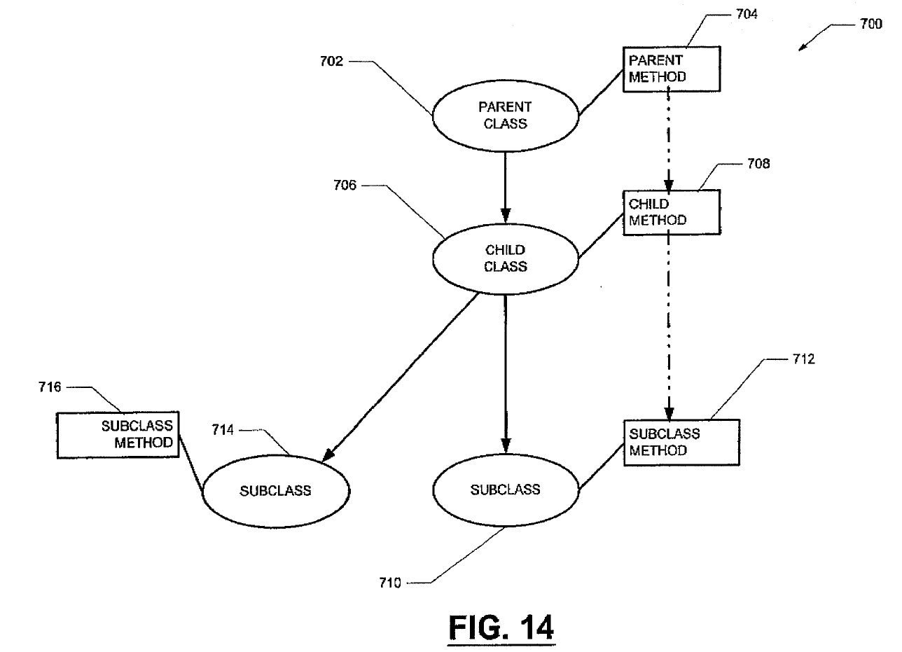

FIG. 14 is a class diagram depicting the simulation of inheritance properties 700 in a scripting language (such as, JavaScript, VBScript, etc.). A parent class 702 is first declared and defined. In JavaScript, the parent class is declared as a function, and the parent class function's operation is then defined within the immediately following code block. The parent class function normally will contain one or more functions itself. Within a function being used as a class, the contained functions will be referred to as methods. A method contained within the parent class function is depicted at 704.

A child class 706 is declared and defined in much the same manner as the parent class is declared and defined. That child class function will contain one or more functions itself. The child class 706 is derived from the parent class 702. At least one of the functions contained within the child class function will have the same name as the parent class's method 704. The child class's method 708 is declared and defined to override the parent method 704. Consequently, the parent method 704 and the child method 708 each have different functionality.

Other subclasses 710 are declared and defined as described for the parent class function and the child class function. These subclass functions can be declared and defined such that they are derived from the class function immediately above it in the hierarchy in a similar manner as the child class 706 is derived from the parent class 702. A subclass 710 that is derived from child class 706 will have child class 706 serve as its parent and will contain subclass method 712 which overrides child method 708. This technique can be applied through multiple generations of declared and defined classes.

Similarly, a subclass 714 can be declared and defined that is itself a derived child class of child class 706. Subclass 714 will contain a subclass method 716 which overrides child method 708. In this fashion, subclass 710 and subclass 714 are sibling classes because both subclass 710 and subclass 714 are derived from the same parent, i.e., child class 706.

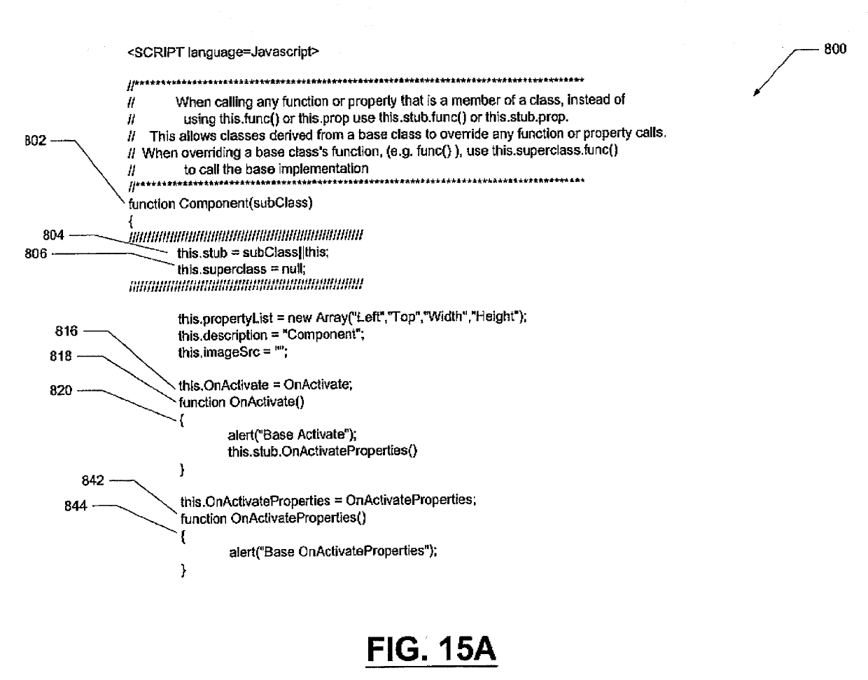

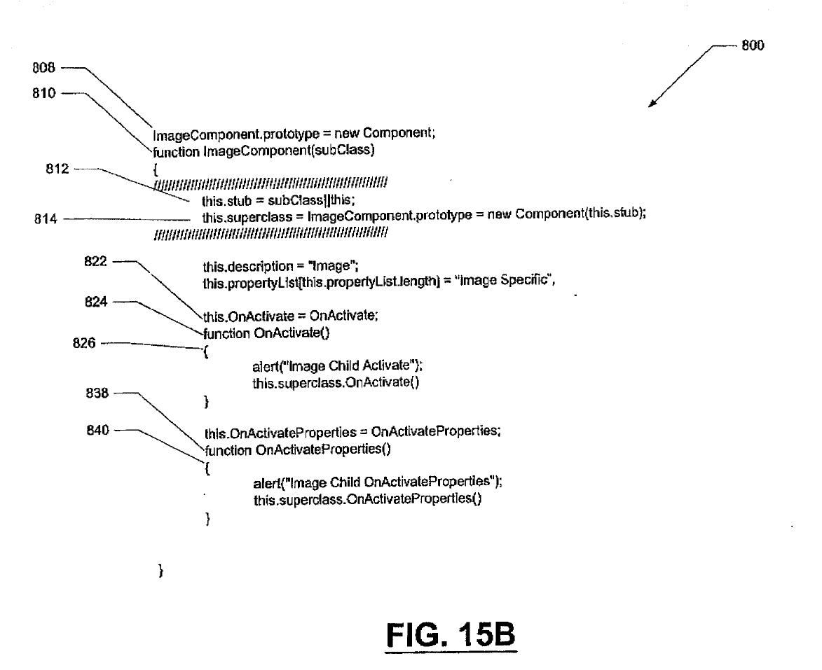

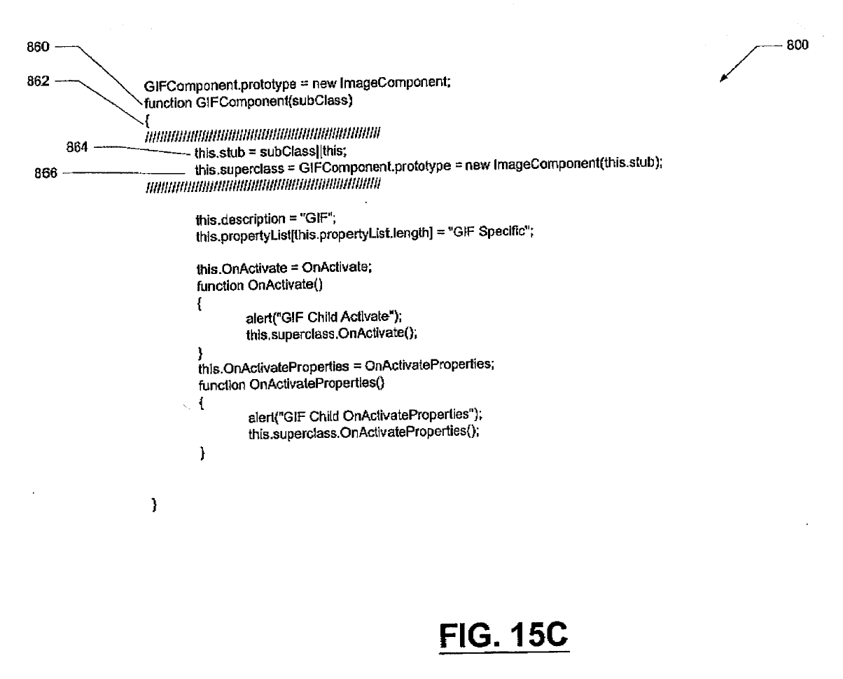

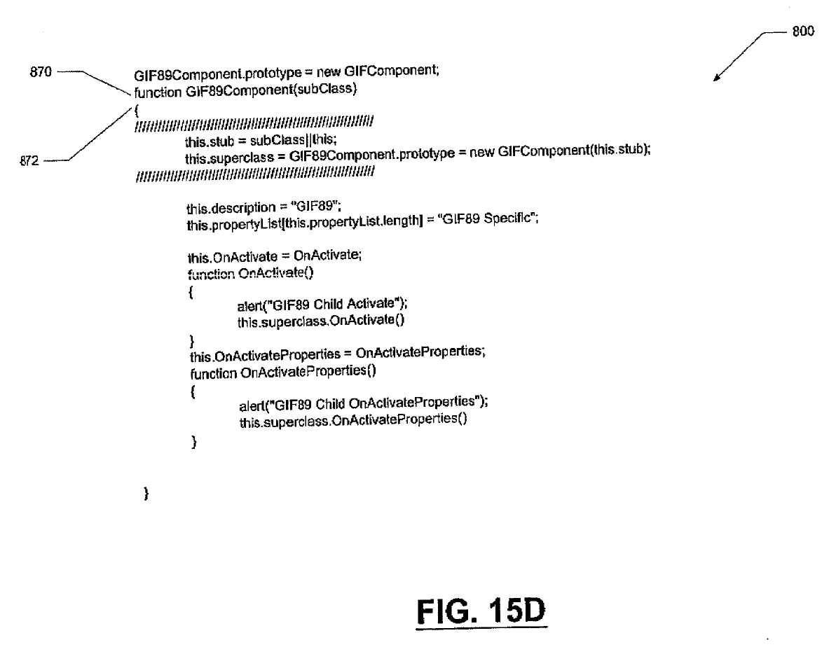

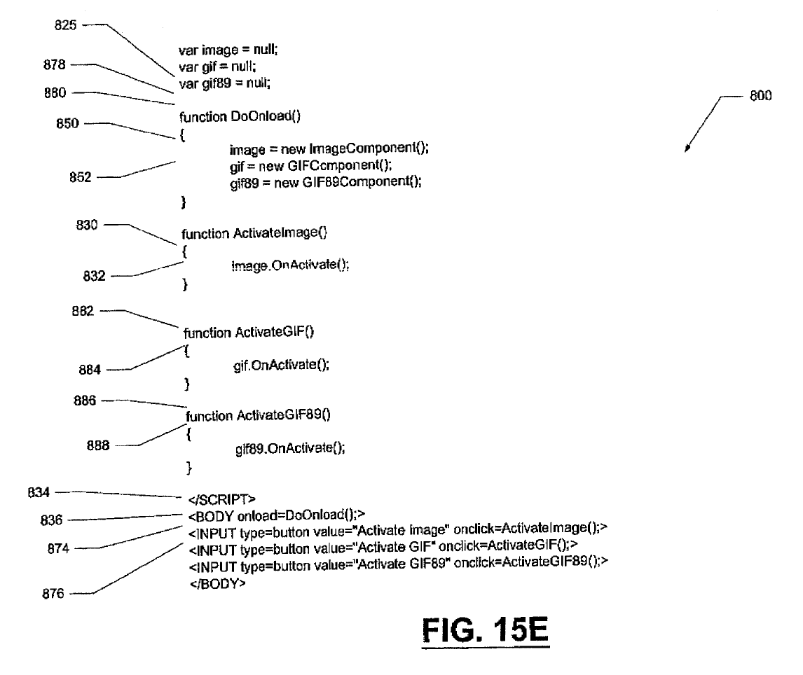

FIGS. 15A through 15E depict JavaScript source code within an HTML page that illustrates the programming method 800 used to simulate the inheritance properties of an object-oriented programming language. In line 802, the programmer declares a function called Component that takes a single argument subClass. In line 804, a variable within the present object, this.stub, is declared and assigned the value from a right hand side logical OR test. The value assigned will be either the value from subClass if one was passed to the Component function, or simply a reference to itself from the right side of the logical OR operator. In line 806, the reference to the superclass object is set to null.

In line 808, the prototype for a function ImageComponent is assigned from a new Component. In line 810, a function ImageComponent is declared. ImageComponent takes a single argument named subClass. The stub variable within the present ImageComponent is assigned a value from the logical OR operation on the right hand side of the assignment operator in line 812 in a similar manner as the operation in line 804. In line 814 two assignments are made. First, a new Component is created by using the new operator and passing this.stub as an argument. Then in line 804 an assignment is made to ImageComponent.prototype. This assignment overwrites the assignment made in line 808. Finally, a second assignment is made in line 804 to this.superclass. After the second assignment, this.superclass refers to the base class, which is that child class's parent.

Both the parent and child classes contain a function called OnActivate. In the parent class, Component, line 816 sets the Component class's OnActivate function to the version of the OnActivate function contained within the Component class. At line 818, the parent class's OnActivate function is declared. Code block 820 contains the functional code for the parent class's OnActivate function declared in line 818.

For the child class, in line 822 the OnActivate function for the child class is set. The child's OnActivate function is declared in line 824. Code block 826 contains the functional code for the child class's OnActivate function declared in line 824. A variable called image is declared and assigned a null value in line 825.

A function DoOnLoad is declared on line 850 with that function's operational code contained in code block 852. Function ActivateImage is declared at line 830 with its operational code contained in code block 832.

The HTML tag at line 834 calls the JavaScript function DoOnLoad from line 850. When the DoOnLoad function executes, the image declared in line 825 is created as an ImageComponent. The HTML tag at line 836 causes an input button to appear on the viewer's screen.

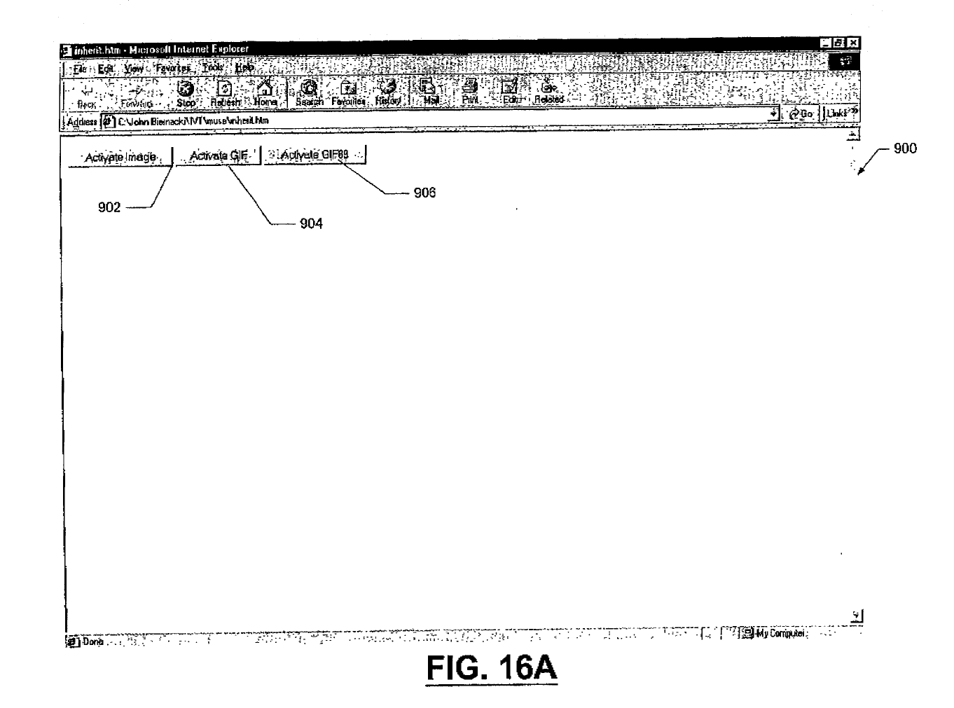

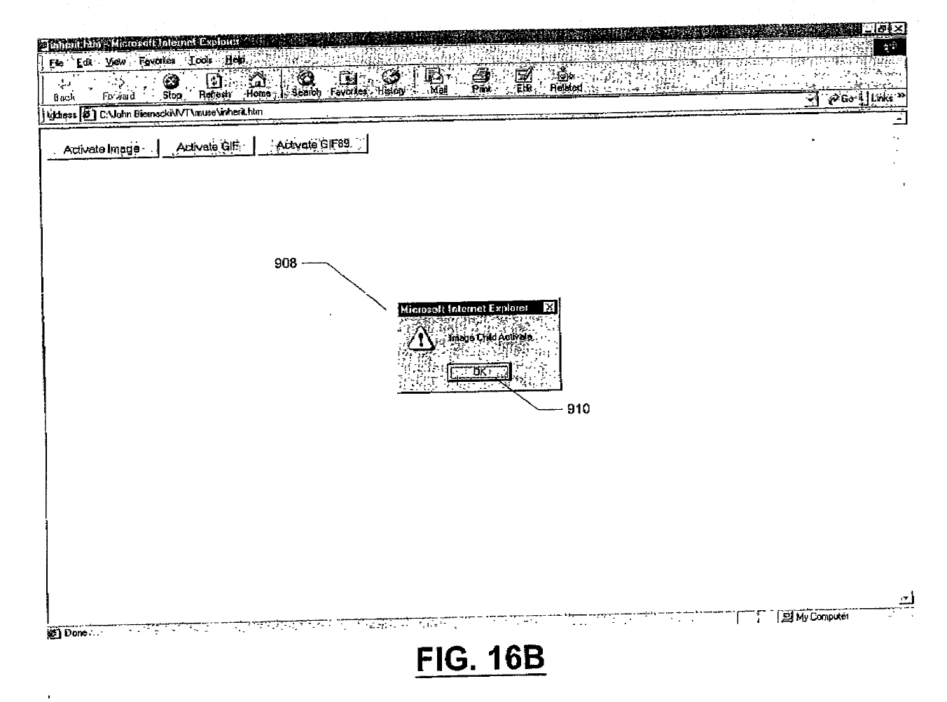

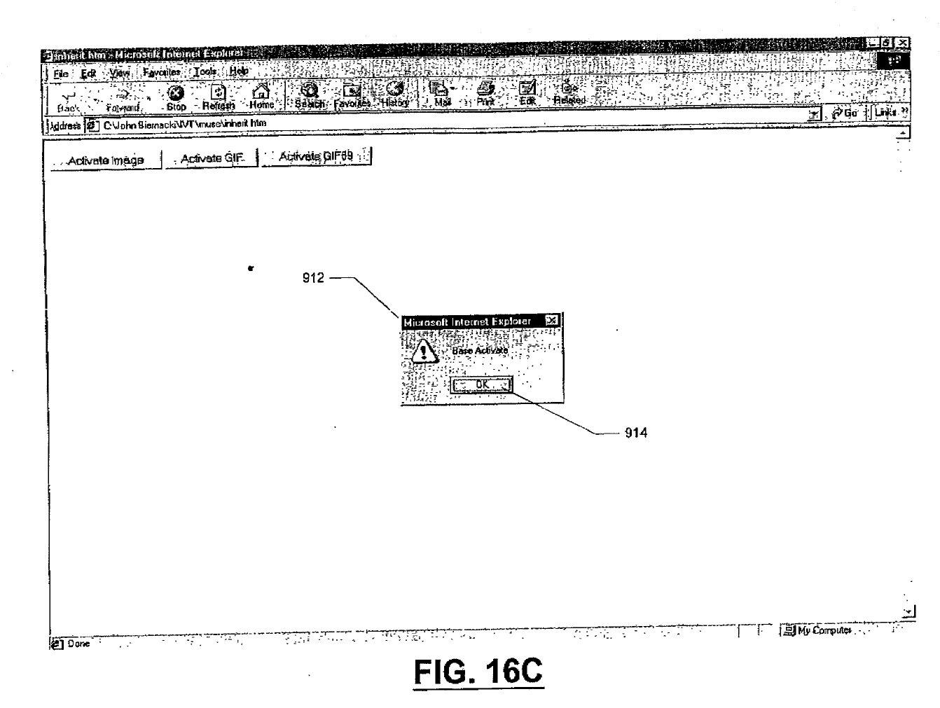

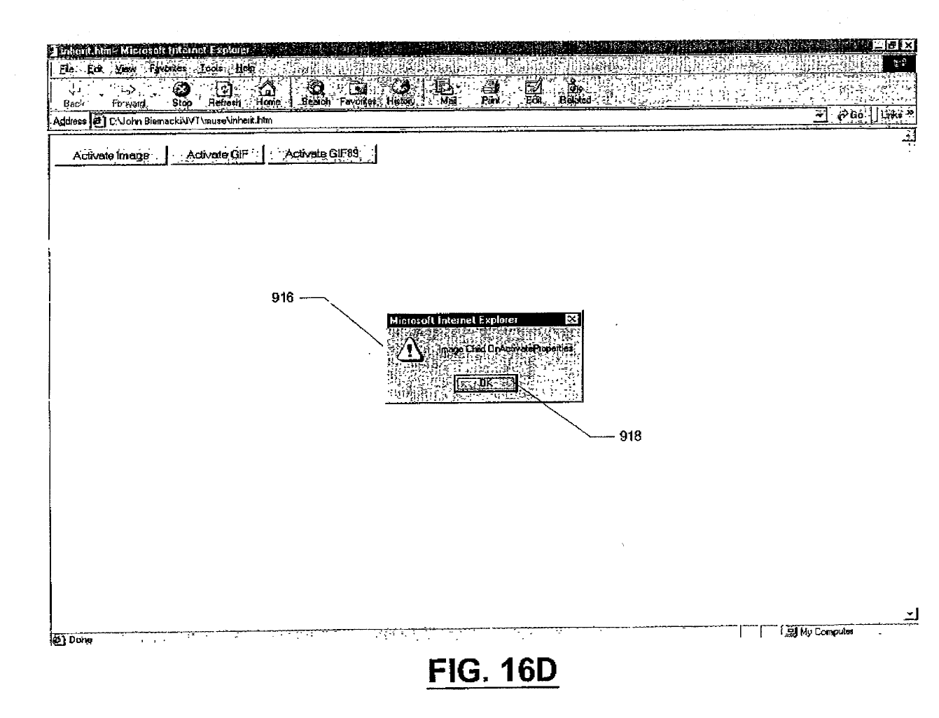

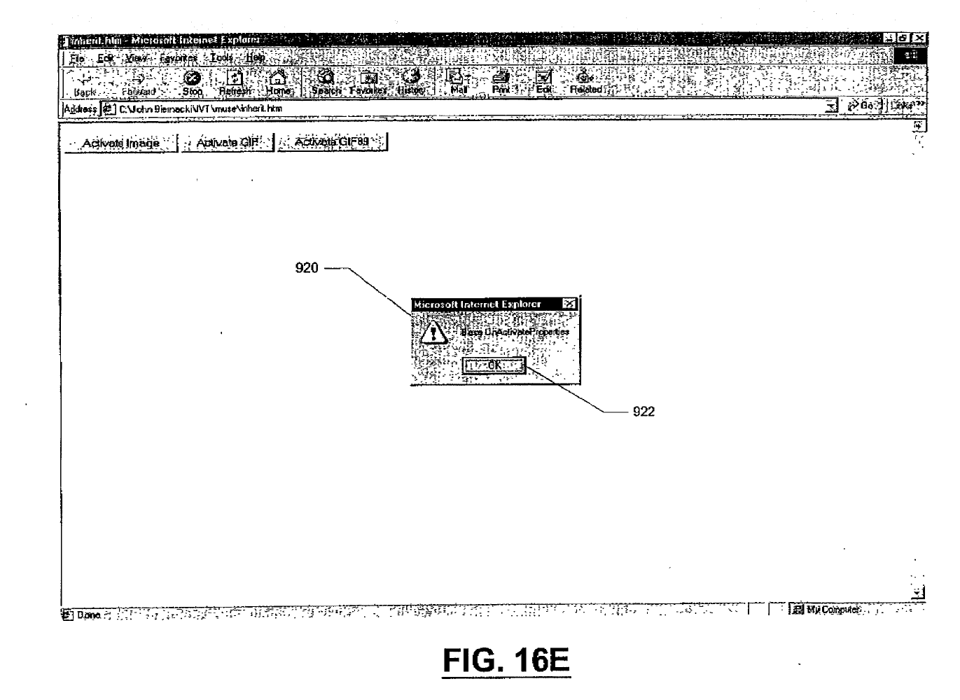

FIG. 16A is a depiction of the graphical user interface displayed to the user when the JavaScript code (depicted in FIGS. 15A through 15E) executes. In FIG. 16A, button 902 is the button created by the HTML code in FIG. 15E at line 836. When that button is clicked, the function ActivateImage, found in line 830 and code block 832, is called. The ActivateImage function, in code block 832, in turn calls image.OnActivate, image's OnActivate function. Because image was created from the child class, the OnActivate function executed is the one that was declared and defined in the ImageComponent function in line 824 and code block 826. The ImageComponent function's OnActivate function first causes an alert with the text “Image Child Activate” to appear on the screen. A graphical depiction of this action is contained in FIG. 16B which shows alert box 908. Once that alert is dismissed by clicking OK button 910, the next line of code within code block 226 executes. This line calls the OnActivate function from the parent class Component which is declared in line 218 and defined in code block 220. While executing, the parent's OnActivate function causes an alert with the text “Base Activate” to appear on screen. A graphical depiction of this action is contained in FIG. 16C which shows alert box 912. Once that alert is dismissed by clicking OK button 914, the OnActivate function in code block 826 completes execution. When that alert is dismissed, the function calls the function OnActivate Properties in the child class at line 838. In code block 840, an alert with the text “Image Child OnActivateProperties” is displayed on the viewer's screen. A graphical depiction of this action is contained in FIG. 16D which shows alert box 916. Once that alert is dismissed by clicking OK button 918, the OnActivateProperties function from the parent class is called. The parent class's OnActivateProperties is declared in line 842 and defined in code block 844. The code in code block 844 causes an alert dialog with the text “Base OnActivateProperties” to appear on the viewer's screen. A graphical depiction of this action is contained in FIG. 16E which shows alert box 920. Processing is completed when the viewer dismisses this alert by clicking OK button 922.

An additional level of inheritance is achieved by deriving a subclass GIFComponent from ImageComponent. The GIFComponent function is declared at line 860 and defined within code block 862. References to GIFComponent's parent class are created in line 864 and 866 in a similar manner as the reference to Component within ImageComponent was previously created. This creation procedure is repeated once more for GIF89Component declared on line 870 and defined in code block 872.

HTML code in line 874 creates button 904 depicted in FIG. 16A. Button 904 causes the function ActivateGIF declared in line 882 and defined in code block 884 to be called. HTML code in line 876 creates button 906 depicted in FIG. 16A. Button 906 causes the function ActivateGIF89 declared in line 886 and defined in code block 888 to be called. Alerts are displayed as described previously with the lowest derived class's alerts displayed first, then those alerts from the lowest derived class's parent, and so forth until the final alert from the topmost parent class is displayed.

Lastly, with respect to all the FIGS. and the entire preceding discussion, it must be understood that the described embodiments are examples of structures, systems and methods having elements corresponding to the elements of the present invention recited in the claims. This written description enables those skilled in the art to make and use embodiments having alternative elements that likewise correspond to the elements of the invention recited in the claims. The intended scope of the invention may thus include other structures, systems or methods that do not differ from the literal language of the claims, and may further include other structures, systems or methods with insubstantial differences from the literal language of the claims. For example, set-top boxes, personal data assistants, and wearable computers may all utilize the claim invention.

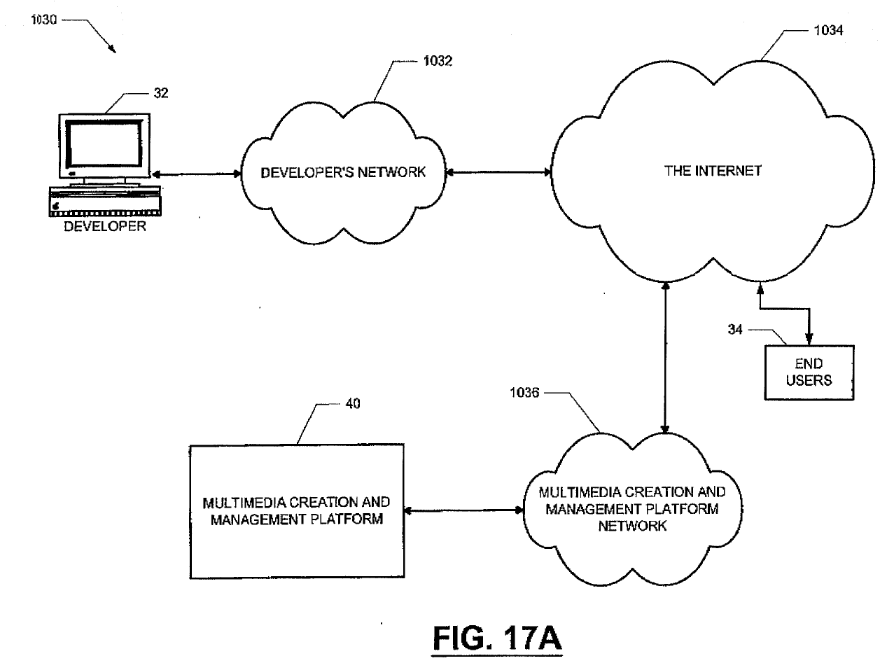

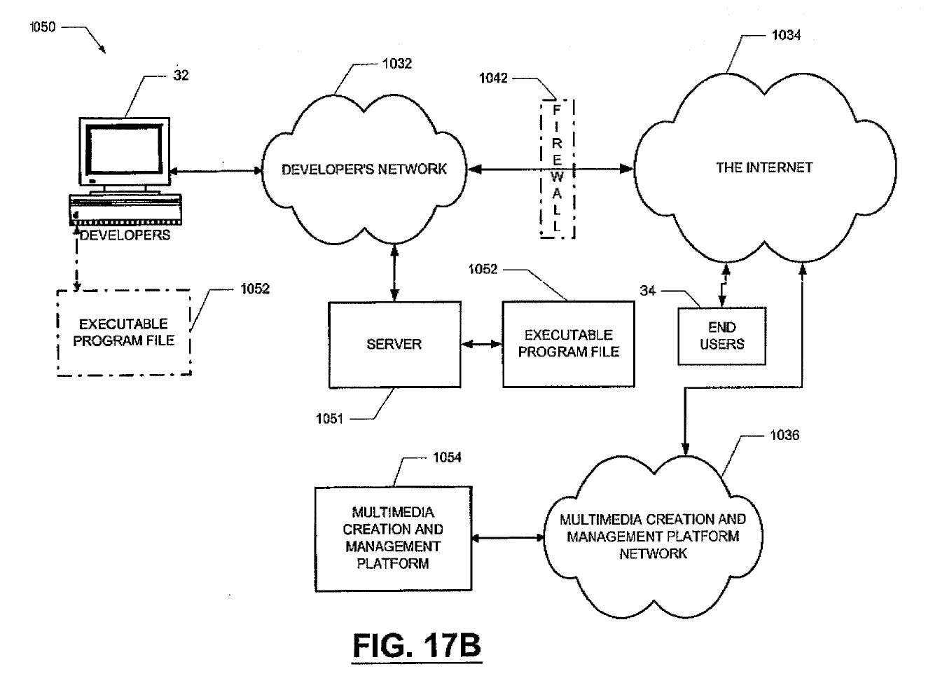

As still further illustrations of the broad range of the present invention, FIGS. 17A and 17B show additional exemplary configurations of the system. FIG. 17A depicts a configuration utilizing an application service provider (ASP) model. In this exemplary ASP model 1030, the developer 32 uses his computer for development work. The developer's computer is connected to a developer's network 1032. The developer's network 1032 is in turn connected to the Internet 1034. The multimedia creation and management platform 40 is connected to a network 1036, and the multimedia creation and management platform network 1036 is connected to the Internet 1034. Through these interconnections, the developer 32 gains access to the functionality provided by the multimedia creation and management platform 40 for eventual delivery to the end users 34.

FIG. 17B depicts another exemplary configuration 1050 of an ASP model. In configuration 1050, the developer's computer 32 is connected to the Internet 1034 through a developer's network 1032. The developer's computer 32 accesses an executable program file 1052. The executable program file 1052 provides portions of the functionality of the multimedia creation and management system 40 (of FIG. 2), such as but not limited to, asset creation and management as well as template creation. The executable program file 1052 may reside on a server 1051 which the developer's computer 32 accesses via the developer's network 1032. (Another configuration is shown in phantom where the executable program file 1052 resides directly on the developer's computer 32.)

The developer's computer 32 accesses a multimedia creation and management platform 1054 to provide functionality not provided by the executable program file 1052, such as provision of content to the end users 34 via streaming video. Those skilled in the art will recognize that a variety of possibilities exist for separating the operations of the multimedia creation and management platform 40 (of FIG. 2) such that some operations are performed by the multimedia creation and management platform 1054 (of FIG. 17B) and others by the executable program file 1052 (of FIG. 17B).

The developer's computer 32 may connect to the multimedia creation and management platform 1054 in many ways. One way is by the developer's network 1032 having a data connection to the network 1036 that contains the multimedia creation and management platform 1054. Such access may be achieved by the developer's network accessing the multimedia creation and management platform network 1036 through the Internet 1034. For added security, a firewall 1042 may be placed between the developer's network 1032 and the Internet 1034. The firewall 1042 may be configured to allow access by the end users 34 to the developer's network 1032 or to allow transmission of content from the developer's network 1032 through the firewall 1042 and ultimately to the end users 34.

Those skilled in the art will recognize that the executable program file 1052 may be implemented as multiple files (such as but not limited to a plurality of dynamic-link library files). Additionally, the Internet 1034, the developer's network 1032, and/or the multimedia creation and management platform network 1036 may be any private or public internetwork or intranetwork, including optical and wireless implementations.

It is claimed:

1. A computer-implemented multimedia content authoring system for managing a plurality of different types of multimedia assets, comprising:
an asset content storage unit that stores representations of the assets;
an asset metadata storage unit that stores metadata about the stored asset representations; and
an asset manager module connected to the asset content storage unit and to the asset metadata storage unit, said asset manager module providing to a developer a computer-human interface to the asset metadata in order to locate at least one asset representation for inclusion into a multimedia application.

2. The system of claim 1 wherein the assets representing an abstraction of asset representations, asset attributes and asset values, wherein groups of assets are formed based upon an aggregation factor, said groups are stored in the asset metadata storage unit for use by the developer in generating the multimedia application.

3. The system of claim 2 wherein the aggregation factor is type of asset.

4. The system of claim 1 wherein a first asset of the assets may be associated with a plurality of asset representations.

5. The system of claim 4 wherein the asset representations are different file formats for the first asset.

6. The system of claim 4 further comprising:
a deployment manager module connected to the asset content storage unit and to the asset metadata storage unit that indicates different computer servers to handle different content based upon asset types.

7. The system of claim 1 wherein a user-defined attribute is associated with an asset and stored in the asset metadata storage unit.

8. The system of claim 1 wherein assets represent an abstraction of asset representations, asset attributes and asset values,
wherein a new asset type is created based upon a preexisting asset type, wherein assets of the new asset type inherit properties from the preexisting asset type.

9. The system of claim 1 further comprising:
a template editor for constructing a template based upon the assets, said template editor allowing run-time behavior of assets on a template to be synchronized.

10. The system of claim 9 further comprising:
a first computer system containing the asset manager module, the template editor, application manager means, project manager means, and deployment manager means; and
a user computer that over a data connection has access to the asset manager module, the template editor, application manager means, project manager means, and deployment manager means on the server computer system, whereby an application service (ASP) providing model is achieved through said network access.

11. The system of claim 9 further comprising:
a user computer that contains at least one program selected from the group consisting of the asset manager module, the template editor, application manager means, project manager means, and deployment manager means; and
a server computer system connected to the user computer through a data connection to provide access for the user computer's program to the asset content storage unit and the asset metadata storage unit.

12. A computer-implemented method for managing and presenting multimedia content comprising the steps of:
creating a presentation template;
selecting at least one media asset for inclusion within the template;
positioning the selected media asset within the template in order to create the multimedia content;
providing the multimedia content to a viewing device during run-time; and
sending a command to the viewing device that alters a design-time property of the multimedia content during the run-time, whereby the multimedia content with the altered design-time property is displayed to a user.

13. The method of claim 12 wherein the viewing device is a computer with a computer display.

14. The method of claim 12 wherein the viewing device is a device selected from the group consisting of a computer display, set-top box, personal data assistant, and a wearable computer.

15. The method of claim 12 wherein the altered design-time property is a font property of text shown in the multimedia content.

16. The method of claim 12 further comprising the steps of:
streaming video data to the viewing device; and
injecting an event into the streamed video data in order to alter the design-time property of the multimedia content during run-time.

17. The method of claim 16 wherein the video data is streamed using a user datagram protocol (UDP), and the injected event is sent to the viewing device using the transmission control protocol (TCP).

18. A computer-implemented method for presenting multimedia content comprising the steps of:
selecting at least two multimedia assets for inclusion into a multimedia application;
during design-time, modifying run-time behavior characteristics of one of the assets to be synchronized with the run-time behavior characteristics of another selected asset;
providing the multimedia application to a viewing device; and
presenting the selected assets such that their presentation is synchronized with respect to each other.

19. The method of claim 18 wherein the assets are synchronized based upon a presentation timing factor.

20. The method of claim 18 wherein the assets are synchronized based upon a predetermined event occurring.

21. The method of claim 20 wherein the predetermined event includes a clicking event involving one of the assets.

22. A computer-implemented method for preparing multimedia content for presentation through a viewing device, comprising the steps of:
receiving from the viewing device a presentation-related request for the content;
determining operational characteristics associated with the viewing device;
selecting which presentation-related instructions are to be transmitted as part of the content to the viewing device based upon the determined operational characteristics; and
transmitting to the viewing device the selected instructions that are part of the requested content.

23. The method of claim 22 wherein the presentation-related request is a request for a web page that is to contain instructions on how content is to be displayed through the viewing device.

24. The method of claim 22 wherein the operational characteristics associated with the viewing device include the hardware display characteristics.

25. The method of claim 22 wherein the operational characteristics associated with the viewing device include the processes operational on the viewing device.

26. The method of claim 22 wherein the operational characteristics associated with the viewing device include the connection characteristics between the viewing device and a server that is servicing the presentation-related request.

27. The method of claim 22 further comprising the steps of:
storing an application in a markup language format;
retrieving the application in the markup language format in response to the presentation-related request; and
generating the presentation-related instructions from the markup language format of the application and determining which presentation-related instructions to transmit to the viewing device based upon the determined operational characteristics.

28. The method of claim 27 wherein the markup language format is an Extensible Markup Language (XML).
